(19) United States
(12) Patent Application Publication
(10) Pub. No.: US 2011/0289455 A1
(43) Pub. Date: Nov. 24, 2011

(54) Gestures And Gesture Recognition For Manipulating A User-Interface

(75) Inventors: Brendan Reville, Seattle, WA (US); Ali Vassigh, Redmond, WA (US); Arjun Dayal, Redmond, WA (US); Christian Klein, Duvall, WA (US); Adam Poulos, Redmond, WA (US); Andy Mattingly, Kirkland, WA (US)

(73) Assignee: MICROSOFT CORPORATION, Redmond, WA (US)

(21) Appl. No.: 12/782,377

(22) Filed: May 18, 2010

(51) Int. Cl. G06F 3/033; G06F 3/048; G06T 7/00

(52) U.S. Cl. 715/830; 382/103; 715/863

(57) ABSTRACT

Symbolic gestures and associated recognition technology are provided for controlling a system user-interface, such as that provided by the operating system of a general computing system or multimedia console. The symbolic gesture movements in mid-air are performed by a user with or without the aid of an input device. A capture device is provided to generate depth images for three-dimensional representation of a capture area including a human target. The human target is tracked using skeletal mapping to capture the mid-air motion of the user. The skeletal mapping data is used to identify movements corresponding to pre-defined gestures using gesture filters that set forth parameters for determining when a target's movement indicates a viable gesture. When a gesture is detected, one or more pre-defined user-interface control actions are performed.

### BACKGROUND

In the past, computing applications such as computer games and multimedia applications used controllers, remotes, keyboards, mice, or the like to allow users to manipulate game characters or other aspects of an application. More recently, computer games and multimedia applications have begun employing cameras and software gesture recognition to provide a human computer interface (“HCI”). With HCI, user gestures are detected, interpreted and used to control game characters or other aspects of an application.

### SUMMARY

A system user-interface, such as that provided by the operating system of a general computing system or multimedia console, is controlled using symbolic gestures. Symbolic gesture movements in mid-air are performed by a user with or without the aid of an input device. A target tracking system analyzes these mid-air movements to determine when a pre-defined gesture has been performed. A capture device produces depth images of a capture area including a human target. The capture device generates the depth images for three-dimensional representation of the capture area including the human target. The human target is tracked using skeletal mapping to capture the mid-air motion of the user. The skeletal mapping data is used to identify movements corresponding to pre-defined gestures using gesture filters that set forth parameters for determining when a target's movement indicates a viable gesture. When a gesture is detected, one or more pre-defined user-interface control actions are performed.

A user-interface is controlled in one embodiment using mid-air movement of a human target. Movement of the human target is tracked using images from a capture device to generate a skeletal mapping of the human target. From the skeletal mapping it is determined whether the movement of the human target satisfies one or more filters for a particular mid-air gesture. The one or more filters may specify that the mid-air gesture be performed by a particular hand or by both hands, for example. If the movement of the human target satisfies the one or more filters, one or more user-interface actions corresponding to the mid-air gesture are performed.

One embodiment includes a system for tracking user movement to control a user-interface. The system includes an operating system that provides the user-interface, a tracking system, a gestures library, and a gesture recognition engine. The tracking system is in communication with an image capture device to receive depth information of a capture area including a human target and to create a skeletal model mapping movement of the human target over time. The gestures library stores a plurality of gesture filters, where each gesture filter contains information for at least one gesture. For example, a gesture filter may specify that a corresponding gesture be performed by a particular hand or both hands. The gesture recognition engine is in communication with the tracking system to receive the skeletal model and using the gestures library, determines whether the movement of the human target satisfies one or more of the plurality of gesture filters. When one or more of the plurality of gesture filters are satisfied by the movement of the human target, the gesture recognition engine provides an indication to the operating system, which can perform a corresponding user-interface control action.

One embodiment includes providing a plurality of gesture filters corresponding to each of a plurality of mid-air gestures for controlling an operating system user-interface. The plurality of mid-air gestures include a horizontal fling gesture, a vertical fling gesture, a one-handed press gesture, a back gesture, a two-handed press gesture and a two-handed compression gesture. Movement of a human target is tracked from a plurality of depth images using skeletal mapping of the human target in a known three-dimensional coordinate system. From the skeletal mapping, it is determined whether the movement of the human target satisfies at least one gesture filter for each of the plurality of mid-air gestures. In response to determining that the movement of the human target satisfies one or more of the gesture filters, the operating system user-interface is controlled.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A and 1B illustrate one embodiment of a tracking system with a user playing a game.

FIG. 2 illustrates one embodiment of a capture device that may be used as part of the tracking system.

FIG. 3 illustrates one embodiment of a computing system that may be used to track motion and update an application based on the tracked motion.

FIG. 4 illustrates one embodiment of a computing system that may be used to track motion and update an application based on the tracked motion.

FIG. 5 is a flowchart describing one embodiment of a process for gesture control of a user interface.

FIG. 6 is an example of a skeletal model of a human target that can be generated by a tracking system in one embodiment.

FIG. 7 is a flowchart describing one embodiment of a process for capturing motion to control a user interface.

FIG. 8 is a block diagram describing one embodiment of a gesture recognition engine.

FIGS. 9A-9B are block diagrams illustrating stacking of gesture filters to create more complex gesture filters.

FIG. 10 is a flowchart describing one embodiment of a process for gesture recognition in accordance with one embodiment.

FIGS. 11A-11H depict a skeletal mapping of a human target performing a horizontal fling gesture in accordance with one embodiment.

FIG. 12 depicts a human target interacting with a tracking system to perform a horizontal fling gesture in one embodiment.

FIG. 13 is a flowchart describing a gesture recognition engine applying a right-handed fling gesture filter to a motion capture file for a human target in accordance with one embodiment.

FIGS. 14A and 14B depict a human target interacting with a tracking system to perform a vertical fling gesture in one embodiment.

FIGS. 15A and 15B depict a human target interacting with a tracking system to perform a press gesture in one embodiment.

FIGS. 16A and 16B depict a human target interacting with a tracking system to perform a two-handed press gesture in one embodiment.

FIGS. 17A and 17B depict a human target interacting with a tracking system to perform a two handed compression gesture in one embodiment.

FIG. 18 illustrates one embodiment of a tracking system with a user interacting with a handle provided by the system.

FIG. 19 illustrates a sample screen display including handles according to one embodiment.

FIG. 20 illustrates a sample screen display including handles and rails according to one embodiment.

FIG. 21 illustrates a sample screen display including handles and rails according to one embodiment.

### DETAILED DESCRIPTION

Symbolic gestures and associated recognition technology are provided for controlling a system user-interface, such as that provided by the operating system of a general computing system or multimedia console. The symbolic gesture movements are performed by a user in mid-air with or without the aid of an input device. A capture device is provided to generate depth images for three-dimensional representation of a capture area including a human target. The human target is tracked using skeletal mapping to capture the mid-air motion of the user. The skeletal mapping data is used to identify movements corresponding to pre-defined gestures using gesture filters that set forth parameters for determining when a target's movement indicates a viable gesture. When a gesture is detected, one or more pre-defined user-interface control actions are performed.

A gesture recognition engine utilizing the gesture filters may provide a variety of outputs. In one embodiment, the gesture recognition engine can provide a simple boolean yes/no (gesture satisfied/gesture not satisfied) output in response to analyzing a user's movement using a gesture filter. In other embodiments, the engine can provide a confidence level that a particular gesture filter was satisfied. In some instances, the gesture recognition engine can generate a potentially infinite number of related values to provide additional context regarding the nature of user interaction. For example, the engine may provide values corresponding to a user's current progress toward completing a particular gesture. This can enable a system rendering a user interface, for example, to provide the user with audio and/or visual feedback (e.g., increased pitch of audio or increased brightness of color) during movement as feedback on their progress in completing a gesture.

The detectable gestures in one embodiment include, but are not limited to, a horizontal fling gesture, a vertical fling gesture, a press gesture, a back gesture, a two-handed press gesture, a two-handed back gesture, a two-handed compression gesture and a two-handed reverse compression gesture. A horizontal fling gesture generally includes a horizontal hand movement across a user's body and can trigger a horizontal menu item scrolling action by the user interface. A vertical fling gesture generally includes a vertical hand movement and can trigger a vertical menu item scrolling action by the user interface. A press gesture generally includes a hand movement away from a user's body and toward a capture device, triggering the selection of one or more menu items provided by the user-interface. A back gesture generally includes a hand movement toward a user's body and away from the capture device, triggering backwards navigation through the user-interface, such as from a lower level to a higher level in a menu hierarchy provided by the user-interface. A two-handed press gesture generally includes movement by both hands away from a target's body and toward the capture device, triggering backwards navigation through the user-interface. A two-handed press gesture may also or alternatively trigger a zoom function to zoom out of the current user-interface display. A two-handed compression gesture generally includes a target bringing their hands together in front of their body, triggering a zoom function to zoom out of the current user-interface display. A two-handed compression gesture may also trigger backwards navigation through the user-interface's menu hierarchy. A two-handed compression gesture may further trigger a special operation at the culmination of the movement, such as to collapse a current interface display or to open a menu item in the current display. A two-handed reverse compression gesture generally includes a target beginning with their hands together in front of their body, followed by separating or pulling their hands apart. A two-handed reverse compression gesture may trigger a zoom function to zoom in on the current user-interface view or to navigate forward through the user-interface menu hierarchy.

In one embodiment, one or more gestures are handed, meaning that the movement is associated with a particular hand of the human target. Movement by a right hand can trigger a corresponding user-interface action while the same movement by a left hand will not trigger a corresponding user-interface action. By way of non-limiting example, the system may provide a right-handed horizontal fling gesture and a left-handed horizontal fling gesture whereby a right hand can be used to scroll menu items to the left and a left hand can be used to scroll menu items to the right.

In one embodiment, the system determines a context of the user-interface to identify a set of viable gestures. A limited number of gestures can be defined as viable in a given interface context to make smaller the number of movements that must be identified to trigger user-interface actions. A user identification can be used to modify the parameters defining a particular gesture in one embodiment.

In one embodiment, an on-screen graphical handles system is provided to control interaction between a user and on-screen objects. The handles can be user-interface objects displayed on the display in association with a given object to define what actions a user may perform on a particular object provided by the user-interface, such as for example, scrolling through a textual or graphical navigation menu. A user engages a handle before performing a gesture movement. The gesture movement manipulates the handle, for example, to move the handle up, down, left or right on the display screen. The manipulation results in an associated action being performed on the object.

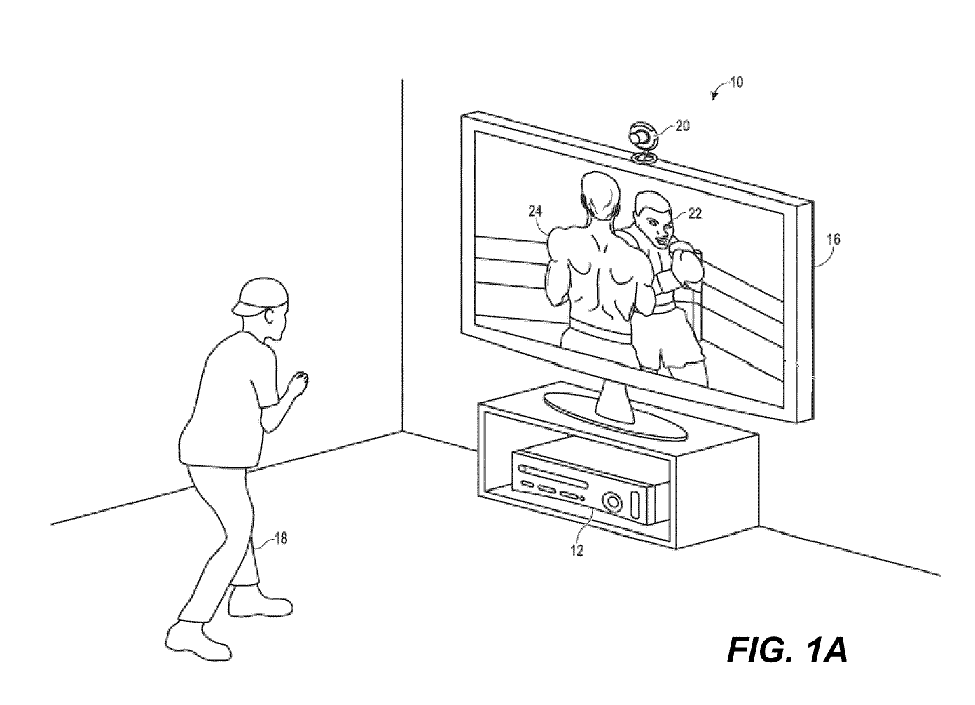

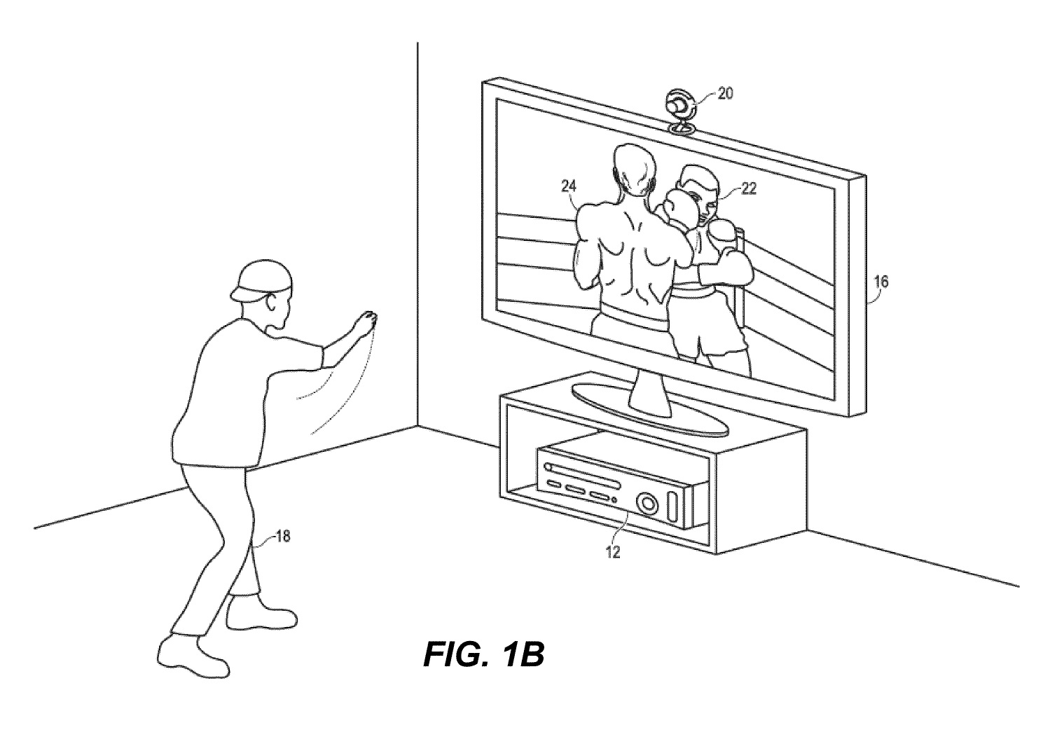

FIGS. 1A and 1B illustrate one embodiment of a target recognition, analysis and tracking system 10 (generally referred to as a tracking system hereinafter) with a user 18 playing a boxing game. The target recognition, analysis and tracking system 10 may be used to recognize, analyze, and/or track a human target such as the user 18.

As shown in FIG. 1A, the tracking system 10 may include a computing environment 12. The computing environment 12 may be a computer, a gaming system or console, or the like. According to one embodiment, the computing environment 12 may include hardware components and/or software components such that the computing environment 12 may be used to execute an operating system and applications such as gaming applications, non-gaming applications, or the like. In one embodiment, computing system 12 may include a processor such as a standardized processor, a specialized processor, a microprocessor, or the like that may execute instructions stored on a processor readable storage device for performing the processes described herein.

As shown in FIG. 1A, the tracking system 10 may further include a capture device 20. The capture device 20 may be, for example, a camera that may be used to visually monitor one or more users, such as the user 18, such that gestures performed by the one or more users may be captured, analyzed, and tracked to perform one or more controls or actions for the user-interface of an operating system or application.

According to one embodiment, the tracking system 10 may be connected to an audiovisual device 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIGS. 1A and 1B, the target recognition, analysis and tracking system 10 may be used to recognize, analyze, and/or track one or more human targets such as the user 18. For example, the user 18 may be tracked using the capture device 20 such that the movements of user 18 may be interpreted as controls that may be used to affect an application or operating system being executed by computer environment 12.

As shown in FIGS. 1A and 1B, the application executing on the computing environment 12 may be a boxing game that the user 18 may be playing. The computing environment 12 may use the audiovisual device 16 to provide a visual representation of a boxing opponent 22 to the user 18. The computing environment 12 may also use the audiovisual device 16 to provide a visual representation of a player avatar 24 that the user 18 may control with his or her movements. For example, as shown in FIG. 1B, the user 18 may throw a punch in physical space to cause the player avatar 24 to throw a punch in game space. Thus, according to an example embodiment, the computer environment 12 and the capture device 20 of the tracking system 10 may be used to recognize and analyze the punch of the user 18 in physical space such that the punch may be interpreted as a game control of the player avatar 24 in game space.

Some movements may be interpreted as controls that may correspond to actions other than controlling the player avatar 24. For example, the player may use movements to end, pause, or save a game, select a level, view high scores, communicate with a friend, etc. The tracking system 10 may be used to interpret target movements as operating system and/or application controls that are outside the realm of games. For example, virtually any controllable aspect of an operating system and/or application may be controlled by movements of the target such as the user 18. According to another embodiment, the player may use movements to select the game or other application from a main user interface. A full range of motion of the user 18 may be available, used, and analyzed in any suitable manner to interact with an application or operating system.

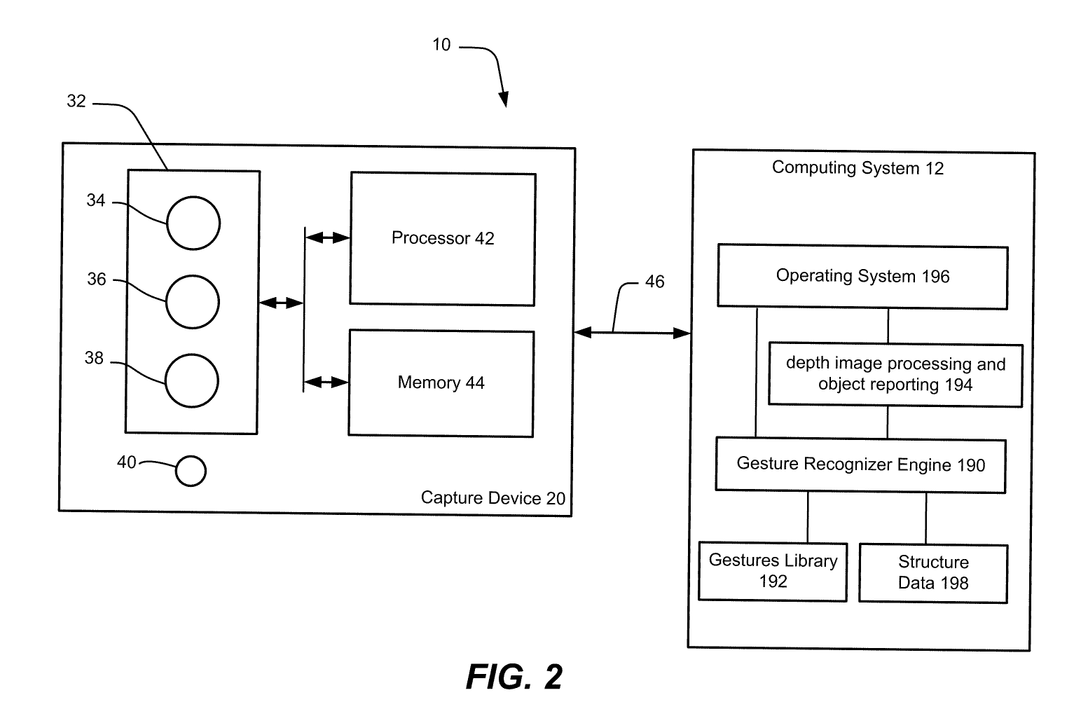

FIG. 2 illustrates one embodiment of a capture device 20 and computing system 12 that may be used in the target recognition, analysis and tracking system 10 to recognize human and non-human targets in a capture area (without special sensing devices attached to the subjects), uniquely identify them and track them in three dimensional space. According to one embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z-axis extending from the depth camera along its line of sight.

As shown in FIG. 2, the capture device 20 may include an image camera component 32. According to one embodiment, the image camera component 32 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 2, the image camera component 32 may include an IR light component 34, a three-dimensional (3-D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more targets and objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

According to one embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more targets or objects in the capture area, the pattern may become deformed in response. Such a deformation of the pattern may be captured by, for example, the 3-D camera 36 and/or the RGB camera 38 and may then be analyzed to determine a physical distance from the capture device to a particular location on the targets or objects.

According to one embodiment, the capture device 20 may include two or more physically separated cameras that may view a capture area from different angles, to obtain visual stereo data that may be resolved to generate depth information. Other types of depth image sensors can also be used to create a depth image.

The capture device 20 may further include a microphone 40. The microphone 40 may include a transducer or sensor that may receive and convert sound into an electrical signal. According to one embodiment, the microphone 40 may be used to reduce feedback between the capture device 20 and the computing environment 12 in the target recognition, analysis and tracking system 10. Additionally, the microphone 40 may be used to receive audio signals that may also be provided by the user to control applications such as game applications, non-game applications, or the like that may be executed by the computing environment 12.

In one embodiment, the capture device 20 may further include a processor 42 that may be in operative communication with the image camera component 32. The processor 42 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction.

The capture device 20 may further include a memory component 44 that may store the instructions that may be executed by the processor 42, images or frames of images captured by the 3-D camera or RGB camera, user profiles or any other suitable information, images, or the like. According to one example, the memory component 44 may include random access memory (RAM), read only memory (ROM), cache, Flash memory, a hard disk, or any other suitable storage component. As shown in FIG. 2, the memory component 44 may be a separate component in communication with the image capture component 32 and the processor 42. In another embodiment, the memory component 44 may be integrated into the processor 42 and/or the image capture component 32. In one embodiment, some or all of the components 32, 34, 36, 38, 40, 42 and 44 of the capture device 20 illustrated in FIG. 2 are housed in a single housing.

The capture device 20 may be in communication with the computing environment 12 via a communication link 46. The communication link 46 may be a wired connection including, for example, a USB connection, a Firewire connection, an Ethernet cable connection, or the like and/or a wireless connection such as a wireless 802.11b, g, a, or n connection. The computing environment 12 may provide a clock to the capture device 20 that may be used to determine when to capture, for example, a scene via the communication link 46.

The capture device 20 may provide the depth information and images captured by, for example, the 3-D camera 36 and/or the RGB camera 38, including a skeletal model that may be generated by the capture device 20, to the computing environment 12 via the communication link 46. The computing environment 12 may then use the skeletal model, depth information, and captured images to, for example, create a virtual screen, adapt the user interface and control an application such as a game or word processor.

Computing system 12 includes gestures library 192, structure data 198, gesture recognition engine 190, depth image processing and object reporting module 194 and operating system 196. Depth image processing and object reporting module 194 uses the depth images to track motion of objects, such as the user and other objects. To assist in the tracking of the objects, depth image processing and object reporting module 194 uses gestures library 190, structure data 198 and gesture recognition engine 190.

Structure data 198 includes structural information about objects that may be tracked. For example, a skeletal model of a human may be stored to help understand movements of the user and recognize body parts. Structural information about inanimate objects may also be stored to help recognize those objects and help understand movement.

Gestures library 192 may include a collection of gesture filters, each comprising information concerning a gesture that may be performed by the skeletal model (as the user moves). A gesture recognition engine 190 may compare the data captured by the cameras 36, 38 and device 20 in the form of the skeletal model and movements associated with it to the gesture filters in the gesture library 192 to identify when a user (as represented by the skeletal model) has performed one or more gestures. Those gestures may be associated with various controls of an application. Thus, the computing system 12 may use the gestures library 190 to interpret movements of the skeletal model and to control operating system 196 or an application (now shown) based on the movements.

In one embodiment, depth image processing and object reporting module 194 will report to operating system 196 an identification of each object detected and the location of the object for each frame. Operating system 196 will use that information to update the position or movement of an avatar or other images in the display or to perform an action on the provided user-interface.

More information about recognizer engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009, both of which are incorporated by reference herein in their entirety. More information about motion detection and tracking can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety.

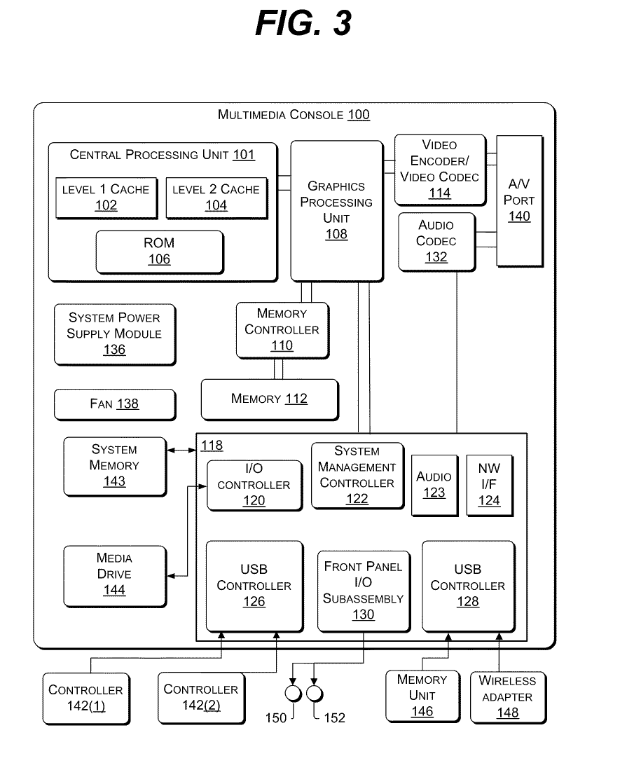

FIG. 3 illustrates an example of a computing environment 100 that may be used to implement the computing environment 12 of FIGS. 1A-2. The computing environment 100 of FIG. 3 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 74 and 76 and capture device 60 may define additional input devices for the console 100.

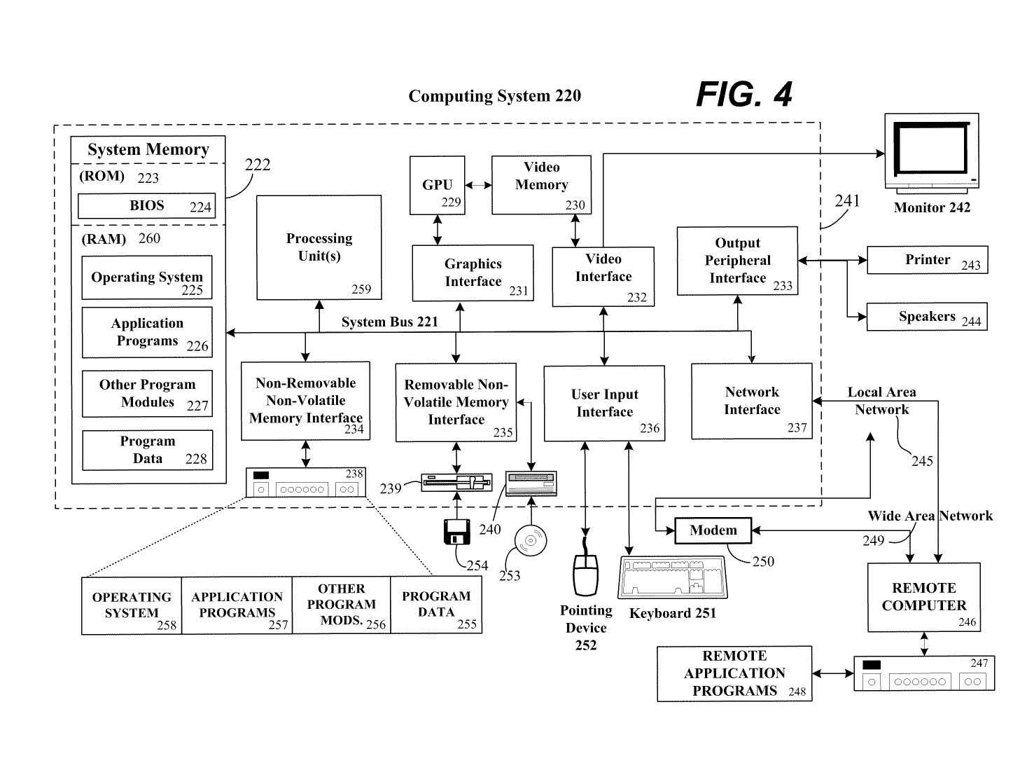

FIG. 4 illustrates another example of a computing environment 220 that may be used to implement the computing environment 52 shown in FIGS. 1A-2. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples, the term circuitry can include a general-purpose processing unit, memory, etc., configured by software instructions that embody logic operable to perform function(s). In embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 74, 76 and capture device 60 may define additional input devices for the computer 241. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

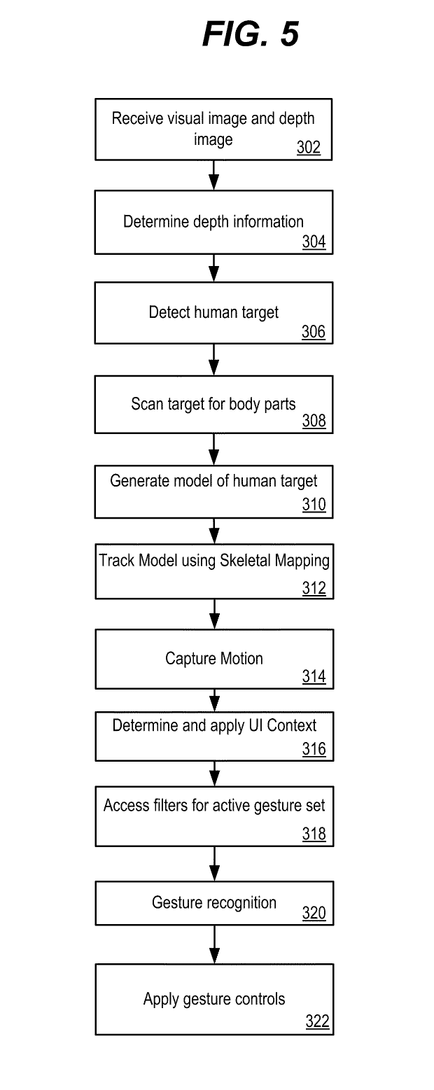

FIG. 5 is a flowchart describing one embodiment of a process for gesture control of a user interface as can be performed by tracking system 10 in one embodiment. At step 302, processor 42 of the capture device 20 receives a visual image and depth image from the image capture component 32. In other examples, only a depth image is received at step 302. The depth image and visual image can be captured by any of the sensors in image capture component 32 or other suitable sensors as are known in the art. In one embodiment the depth image is captured separately from the visual image. In some implementations the depth image and visual image are captured at the same time while in others they are captured sequentially or at different times. In other embodiments the depth image is captured with the visual image or combined with the visual image as one image file so that each pixel has an R value, a G value, a B value and a Z value (representing distance).

At step 304 depth information corresponding to the visual image and depth image are determined. The visual image and depth image received at step 302 can be analyzed to determine depth values for one or more targets within the image. Capture device 20 may capture or observe a capture area that may include one or more targets. At step 306, the capture device determines whether the depth image includes a human target. In one example, each target in the depth image may be flood filled and compared to a pattern to determine whether the depth image includes a human target. In one example, the edges of each target in the captured scene of the depth image may be determined. The depth image may include a two dimensional pixel area of the captured scene for each pixel in the 2D pixel area may represent a depth value such as a length or distance for example as can be measured from the camera. The edges may be determined by comparing various depth values associated with for example adjacent or nearby pixels of the depth image. If the various depth values being compared are greater than a pre-determined edge tolerance, the pixels may define an edge. The capture device may organize the calculated depth information including the depth image into Z layers or layers that may be perpendicular to a Z-axis extending from the camera along its line of sight to the viewer. The likely Z values of the Z layers may be flood filled based on the determined edges. For instance, the pixels associated with the determined edges and the pixels of the area within the determined edges may be associated with each other to define a target or an object in the capture area.

At step 308, the capture device scans the human target for one or more body parts. The human target can be scanned to provide measurements such as length, width or the like that are associated with one or more body parts of a user, such that an accurate model of the user may be generated based on these measurements. In one example, the human target is isolated and a bit mask is created to scan for the one or more body parts. The bit mask may be created for example by flood filling the human target such that the human target is separated from other targets or objects in the capture area elements. At step 310 a model of the human target is generated based on the scan performed at step 308. The bit mask may be analyzed for the one or more body parts to generate a model such as a skeletal model, a mesh human model or the like of the human target. For example, measurement values determined by the scanned bit mask may be used to define one or more joints in the skeletal model. The bitmask may include values of the human target along an X, Y and Z-axis. The one or more joints may be used to define one or more bones that may correspond to a body part of the human.

According to one embodiment, to determine the location of the neck, shoulders, or the like of the human target, a width of the bitmask, for example, at a position being scanned, may be compared to a threshold value of a typical width associated with, for example, a neck, shoulders, or the like. In an alternative embodiment, the distance from a previous position scanned and associated with a body part in a bitmask may be used to determine the location of the neck, shoulders or the like.

In one embodiment, to determine the location of the shoulders, the width of the bitmask at the shoulder position may be compared to a threshold shoulder value. For example, a distance between the two outer most Y values at the X value of the bitmask at the shoulder position may be compared to the threshold shoulder value of a typical distance between, for example, shoulders of a human. Thus, according to an example embodiment, the threshold shoulder value may be a typical width or range of widths associated with shoulders of a body model of a human.

In another embodiment, to determine the location of the shoulders, the bitmask may be parsed downward a certain distance from the head. For example, the top of the bitmask that may be associated with the top of the head may have an X value associated therewith. A stored value associated with the typical distance from the top of the head to the top of the shoulders of a human body may then added to the X value of the top of the head to determine the X value of the shoulders. Thus, in one embodiment, a stored value may be added to the X value associated with the top of the head to determine the X value associated with the shoulders.

In one embodiment, some body parts such as legs, feet, or the like may be calculated based on, for example, the location of other body parts. For example, as described above, the information such as the bits, pixels, or the like associated with the human target may be scanned to determine the locations of various body parts of the human target. Based on such locations, subsequent body parts such as legs, feet, or the like may then be calculated for the human target.

According to one embodiment, upon determining the values of, for example, a body part, a data structure may be created that may include measurement values such as length, width, or the like of the body part associated with the scan of the bitmask of the human target. In one embodiment, the data structure may include scan results averaged from a plurality depth images. For example, the capture device may capture a capture area in frames, each including a depth image. The depth image of each frame may be analyzed to determine whether a human target may be included as described above. If the depth image of a frame includes a human target, a bitmask of the human target of the depth image associated with the frame may be scanned for one or more body parts. The determined value of a body part for each frame may then be averaged such that the data structure may include average measurement values such as length, width, or the like of the body part associated with the scans of each frame. In one embodiment, the measurement values of the determined body parts may be adjusted such as scaled up, scaled down, or the like such that measurements values in the data structure more closely correspond to a typical model of a human body. Measurement values determined by the scanned bitmask may be used to define one or more joints in a skeletal model at step 310.

At step 312 the model created in step 310 is tracked using skeletal mapping. For example, the skeletal model of the user 18 may be adjusted and updated as the user moves in physical space in front of the camera within the field of view. Information from the capture device may be used to adjust the model so that the skeletal model accurately represents the user. In one example this is accomplished by one or more forces applied to one or more force receiving aspects of the skeletal model to adjust the skeletal model into a pose that more closely corresponds to the pose of the human target and physical space. At step 314 motion is captured from the depth images and visual images received from the capture device. In one embodiment capturing motion at step 314 includes generating a motion capture file based on the skeletal mapping as will be described in more detail hereinafter.

At step 316 a user interface context is determined and applied. The UI context may be an environmental context referring to the different environments presented by computing environment 12. For example, there may be a different context among different environments of a single application running on computer device 12. For example, a first person shooter game may involve operating a motor vehicle which corresponds to a first context. The game may also involve controlling a game character on foot which may correspond to a second context. While operating the vehicle in the first context, movements or gestures may represent a first function or first set of functions while in the second context of being on foot those same motions or gestures may represent different functions. For example, extending the first in front and away from the body while in a foot context may represent a punch, while in the driving context the same motion may represent a gear shifting gesture. Further, the context may correspond to one or more menu environments where the user can save a game, select among character equipment or perform similar actions that do not comprise direct game play. In that environment or context, the same gesture may have a third meaning such as to select something or to advance to another screen or to go back from a current screen or to zoom in or zoom out on the current screen. Step 316 can include determining and applying more than one UI context. For example, where two users are interfacing with the capture device and computing environment, the UI context may include a first context for a first user and a second context for the second user. In this example, context can include a role played by the user such as where one user is a driver and another user is a shooter for example.

At step 318 the gesture filters for the active gesture set are determined. Step 318 can be performed based on the UI context or contexts determined in step 316. For example, a first set of gestures may be active when operating in a menu context while a different set of gestures may be active while operating in a game play context. At step 320 gesture recognition is performed. The tracking model and captured motion are passed through the filters for the active gesture set to determine whether any active gesture filters are satisfied. At step 322 any detected gestures are applied within the computing environment to control the user interface provided by computing environment 12.

In one embodiment, steps 316-322 are performed by computing device 12. Furthermore, although steps 302-314 are described as being performed by capture device 20, various ones of these steps may be performed by other components, such as by computing environment 12. For example, the capture device 20 may provide the visual and/or depth images to the computing environment 12 which will in turn, determine depth information, detect the human target, scan the target, generate and track the model and capture motion of the human target.

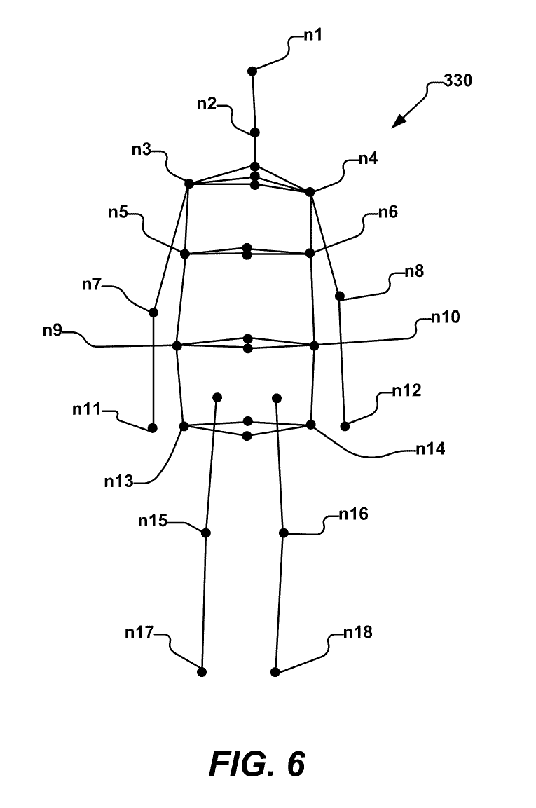

FIG. 6 illustrates an example of a skeletal model or mapping 330 representing a scanned human target that may be generated at step 310 of FIG. 5. According to one embodiment, the skeletal model 330 may include one or more data structures that may represent a human target as a three-dimensional model. Each body part may be characterized as a mathematical vector defining joints and bones of the skeletal model 330.

Skeletal model 330 includes joints n1-n18. Each of the joints n1-n18 may enable one or more body parts defined there between to move relative to one or more other body parts. A model representing a human target may include a plurality of rigid and/or deformable body parts that may be defined by one or more structural members such as “bones” with the joints n1-n18 located at the intersection of adjacent bones. The joints n1-n18 may enable various body parts associated with the bones and joints n1-n18 to move independently of each other or relative to each other. For example, the bone defined between the joints n7 and n11 corresponds to a forearm that may be moved independent of, for example, the bone defined between joints n15 and n17 that corresponds to a calf. It is to be understood that some bones may correspond to anatomical bones in a human target and/or some bones may not have corresponding anatomical bones in the human target.

The bones and joints may collectively make up a skeletal model, which may be a constituent element of the model. An axial roll angle may be used to define a rotational orientation of a limb relative to its parent limb and/or the torso. For example, if a skeletal model is illustrating an axial rotation of an arm, a roll joint may be used to indicate the direction the associated wrist is pointing (e.g., palm facing up). By examining an orientation of a limb relative to its parent limb and/or the torso, an axial roll angle may be determined. For example, if examining a lower leg, the orientation of the lower leg relative to the associated upper leg and hips may be examined in order to determine an axial roll angle.

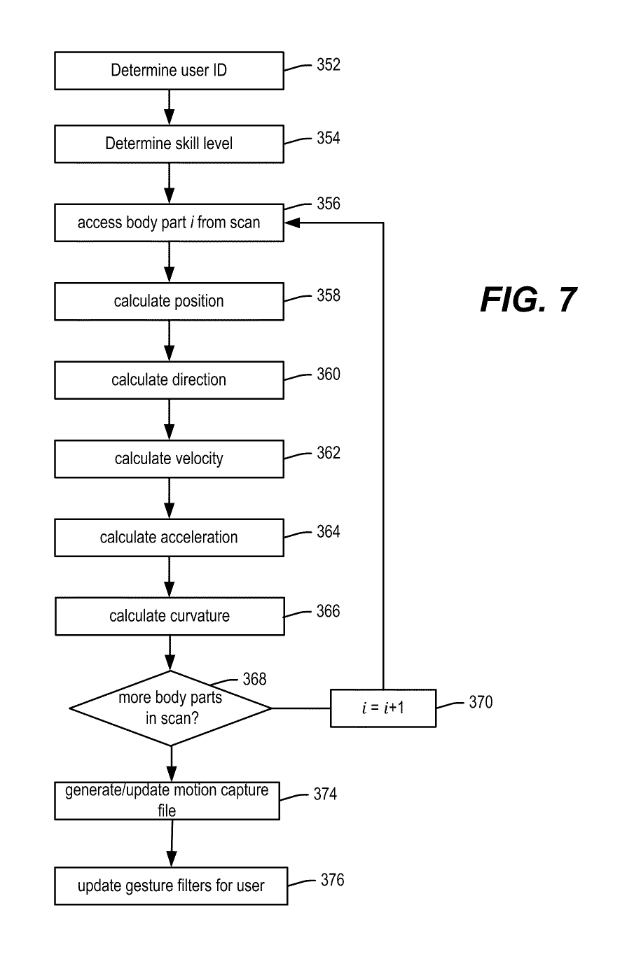

FIG. 7 is a flowchart describing one embodiment of a process for capturing motion using one or more capture devices including depth cameras, and tracking a target within the capture device's field of view for controlling a user interface. FIG. 7 provides more detail for tracking a model and capturing motion as performed at steps 312 and 314 of FIG. 5 in one example.

At step 352 a user identity of a human target in the field of view is determined. Step 352 is optional. In one example, step 352 can use facial recognition to correlate the user's face from a received visual image with a reference visual image. In another example, determining the user I.D. can include receiving input from the user identifying their I.D. For example, a user profile may be stored by computer environment 12 and the user may make an on screen selection to identify themselves as corresponding to that user profile. Other examples for determining an I.D. of a user can be used. At step 354 the skill level of the identified user is determined. Step 354 is optional. In one example, determining the skill level includes accessing a skill level stored with the user profile in the computing environment. In another example, step 354 is performed dynamically by examining the user's interaction with the computing environment. For example, by analyzing the user's movements, gestures and ability to control an application or the user interface may be used to establish a skill level. This process can be dynamic and updated regularly or continuously as the user interacts with the system. In one example, a user's identity and skill level can be used to adjust gesture filters as will be described hereinafter.

To track the user's motion, skeletal mapping of the target's body parts is utilized. At step 356 a body part i resulting from scanning the human target and generating a model at steps 308 and 310 is accessed. At step 358 the position of the body part is calculated in X, Y, Z space to create a three dimensional positional representation of the body part within the field of view of the camera. At step 360 a direction of movement of the body part is calculated, dependent upon the position. The directional movement may have components in any one of or a combination of the X, Y, and Z directions. In step 362, the body part's velocity of movement is determined. At step 364 the body part's acceleration is calculated. At step 366 the curvature of the body part's movement in the X, Y, Z space is determined, for example, to represent non-linear movement within the capture area by the body part. The velocity, acceleration and curvature calculations are not dependent upon the direction. It is noted that steps 358 through 366 are but an example of calculations that may be performed for skeletal mapping of the user's movement. In other embodiments, additional calculations may be performed or less than all of the calculations illustrated in FIG. 7 can be performed. In step 368 the tracking system determines whether there are more body parts identified by the scan at step 308. If there are additional body parts in the scan, i is set to i+1 at step 370 and the method returns to step 356 to access the next body part from the scanned image. The use of X, Y, Z Cartesian mapping is provided only as an example. In other embodiments, different coordinate mapping systems can be used to calculate movement, velocity and acceleration. A spherical coordinate mapping, for example, may be useful when examining the movement of body parts which naturally rotate around joints.

Once all body parts in the scan have been analyzed as determined at step 370, a motion capture file is generated or updated for the target at step 374. The target recognition analysis and tracking system may render and store a motion capture file that can include one or more motions such as a gesture motion. In one example, the motion capture file is generated in real time based on information associated with the tracked model. For example, in one embodiment the motion capture file may include the vectors including X, Y, and Z values that define the joints and bones of the model as it is being tracked at various points in time. As described above, the model being tracked may be adjusted based on user motions at various points in time and a motion capture file of the model for the motion may be generated and stored. The motion capture file may capture the tracked model during natural movement by the user interacting with the target recognition analysis and tracking system. For example, the motion capture file may be generated such that the motion capture file may naturally capture any movement or motion by the user during interaction with the target recognition analysis and tracking system. The motion capture file may include frames corresponding to, for example, a snapshot of the motion of the user at different points in time. Upon capturing the tracked model, information associated with the model including any movements or adjustment applied thereto at a particular point in time may be rendered in a frame of the motion capture file. The information in the frame may include for example the vectors including the X, Y, and Z values that define the joints and bones of the tracked model and a time stamp that may be indicative of a point in time in which for example the user performed the movement corresponding to the pose of the tracked model.

In step 376 the system adjusts the gesture settings for the particular user being tracked and modeled, if warranted. The gesture settings can be adjusted based on the information determined at steps 352 and 354 as well as the information obtained for the body parts and skeletal mapping performed at steps 356 through 366. In one particular example, if a user is having difficulty completing one or more gestures, the system can recognize this for example, by parameters nearing but not meeting the threshold requirements for the gesture recognition. In such a case, adjusting the gesture settings can include relaxing the constraints for performing the gesture as identified in one or more gesture filters for the particular gesture. Similarly, if a user demonstrates a high level of skill, the gesture filters may be adjusted to constrain the movement to more precise renditions so that false positives can be avoided. In other words, by tightening the constraints of a skilled user, it will be less likely that the system will misidentify a movement as a gesture when no gesture was intended.

In one embodiment, a motion capture file as described below may be applied to an avatar or game character or the user interface. For example, the target recognition, analysis and tracking system may apply one or more motions of the tracked model captured in the motion capture file to an avatar or game character such that the avatar or game character may be animated to mimic motions performed by the user such as the user 18 described above with respect to FIGS. 1A and 1B.

In another example, the system may apply pre-determined actions to the user-interface based on one or more motions of the tracked model that satisfy one or more gesture filters. The joints and bones in the model captured in the motion capture file may be mapped to particular portions of the game character or avatar. For example, the joint associated with the right elbow may be mapped to the right elbow of the avatar or game character. The right elbow may then be animated to mimic the motions of the right elbow associated with the model of the user in each frame of the motion capture file, or the right elbow's movement may be passed to a gesture filter to determine if the corresponding constraints have been satisfied.

According to one example, the tracking system may apply the one or more motions as the motions are captured in the motion capture file. Thus, when a frame is rendered in the motion capture file, the motions captured in the frame may be applied to the avatar, game character or user-interface such that the avatar or game character may be animated to immediately mimic the motions captured in the frame. Similarly, the system may apply the UI actions as the motions are determined to satisfy one or more gesture filters.

In another embodiment, the tracking system may apply the one or more motions after the motions are captured in a motion capture file. For example, a motion such as a walking motion or a motion such as a press or fling gesture, described below, may be performed by the user and captured and stored in the motion capture file. The motion may then be applied to the avatar, game character or user interface each time, for example, the user subsequently performs a gesture recognized as a control associated with the motion such as the walking motion or press gesture.

The system may include gesture recognition, so that a user may control an application or operating system executing on the computing environment 12, which as discussed above may be a game console, a computer, or the like, by performing one or more gestures. In one embodiment, a gesture recognizer engine, the architecture of which is described more fully below, is used to determine from a skeletal model of a user when a particular gesture has been made by the user.

Through moving his body, a user may create gestures. A gesture comprises a motion or pose by a user that may be captured as image data and parsed for meaning A gesture may be dynamic, comprising a motion, such as mimicking throwing a ball. A gesture may be a static pose, such as holding one's crossed forearms in front of his torso. A gesture may also incorporate props, such as by swinging a mock sword. A gesture may comprise more than one body part, such as clapping the hands 402 together, or a subtler motion, such as pursing one's lips.

Gestures may be used for input in a general computing context. For instance, various motions of the hands or other body parts may correspond to common system wide tasks such as navigate up or down in a hierarchical menu structure, scroll items in a menu list, open a file, close a file, and save a file. Gestures may also be used in a video-game-specific context, depending on the game. For instance, with a driving game, various motions of the hands and feet may correspond to steering a vehicle in a direction, shifting gears, accelerating, and braking.

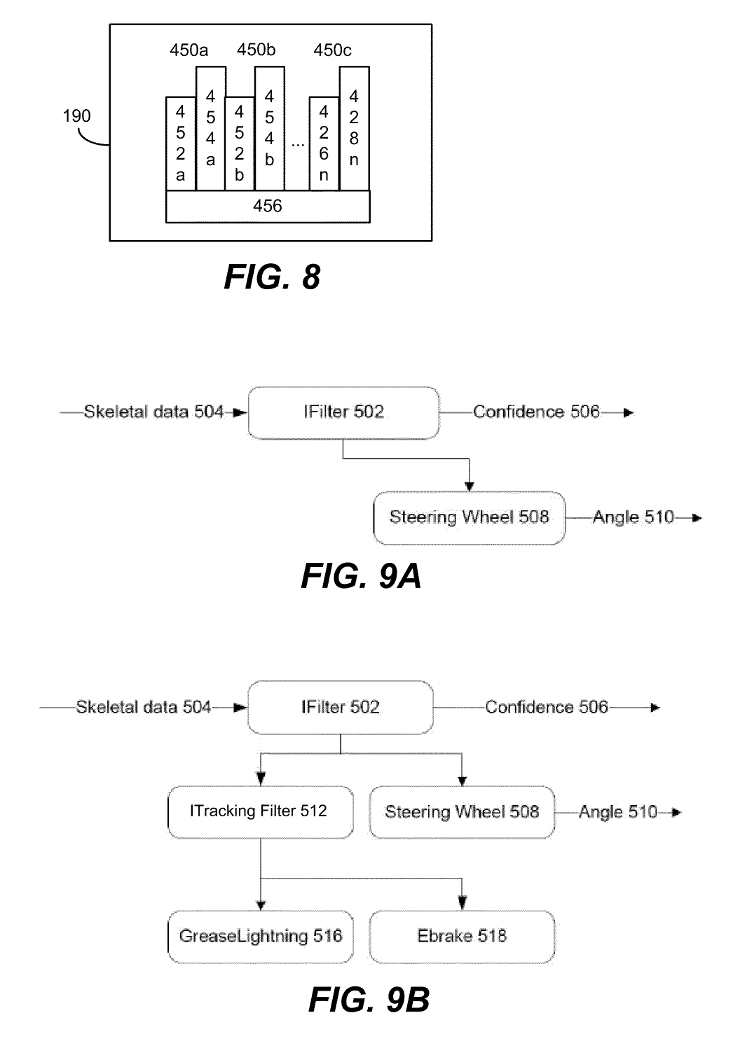

FIG. 8 provides further details of one exemplary embodiment of the gesture recognizer engine 190 of FIG. 2. As shown, the gesture recognizer engine 190 may comprise at least one filter 450 to determine a gesture or gestures. A filter 450 comprises parameters defining a gesture 452 (hereinafter referred to as a “gesture”) along with metadata 454 for that gesture. A filter may comprise code and associated data that can recognize gestures or otherwise process depth, RGB, or skeletal data. For instance, a throw, which comprises motion of one of the hands from behind the rear of the body to past the front of the body, may be implemented as a gesture 452 comprising information representing the movement of one of the hands of the user from behind the rear of the body to past the front of the body, as that movement would be captured by the depth camera. Parameters 454 may then be set for that gesture 452. Where the gesture 452 is a throw, a parameter 454 may be a threshold velocity that the hand has to reach, a distance the hand must travel (either absolute, or relative to the size of the user as a whole), and a confidence rating by the recognizer engine that the gesture occurred. These parameters 454 for the gesture 452 may vary between applications, between contexts of a single application, or within one context of one application over time. Gesture parameters may include threshold angles (e.g., hip-thigh angle, forearm-bicep angle, etc.), a number of periods where motion occurs or does not occur, a threshold period, threshold position (starting, ending), direction of movement, velocity, acceleration, coordination of movement, etc.

A filter may comprise code and associated data that can recognize gestures or otherwise process depth, RGB, or skeletal data. Filters may be modular or interchangeable. In an embodiment, a filter has a number of inputs, each of those inputs having a type, and a number of outputs, each of those outputs having a type. In this situation, a first filter may be replaced with a second filter that has the same number and types of inputs and outputs as the first filter without altering any other aspect of the recognizer engine architecture. For instance, there may be a first filter for driving that takes as input skeletal data and outputs a confidence that the gesture associated with the filter is occurring and an angle of steering. Where one wishes to substitute this first driving filter with a second driving filter—perhaps because the second driving filter is more efficient and requires fewer processing resources—one may do so by simply replacing the first filter with the second filter so long as the second filter has those same inputs and outputs—one input of skeletal data type, and two outputs of confidence type and angle type.

A filter need not have a parameter. For instance, a “user height” filter that returns the user's height may not allow for any parameters that may be tuned. An alternate “user height” filter may have tunable parameters—such as to whether to account for a user's footwear, hairstyle, headwear and posture in determining the user's height.

Inputs to a filter may comprise things such as joint data about a user's joint position, like angles formed by the bones that meet at the joint, RGB color data from the capture area, and the rate of change of an aspect of the user. Outputs from a filter may comprise things such as the confidence that a given gesture is being made, the speed at which a gesture motion is made, and a time at which a gesture motion is made.

The gesture recognizer engine 190 may have a base recognizer engine 456 that provides functionality to a gesture filter 450. In an embodiment, the functionality that the base recognizer engine 456 implements includes an input-over-time archive that tracks recognized gestures and other input, a Hidden Markov Model implementation (where the modeled system is assumed to be a Markov process—one where a present state encapsulates any past state information necessary to determine a future state, so no other past state information must be maintained for this purpose—with unknown parameters, and hidden parameters are determined from the observable data), as well as other functionality required to solve particular instances of gesture recognition.

Filters 450 are loaded and implemented on top of the base recognizer engine 456 and can utilize services provided by the engine 456 to all filters 450. In an embodiment, the base recognizer engine 456 processes received data to determine whether it meets the requirements of any filter 450. Since these provided services, such as parsing the input, are provided once by the base recognizer engine 456 rather than by each filter 450, such a service need only be processed once in a period of time as opposed to once per filter 450 for that period, so the processing required to determine gestures is reduced.

An application may use the filters 450 provided by the recognizer engine 190, or it may provide its own filter 450, which plugs in to the base recognizer engine 456. In an embodiment, all filters 450 have a common interface to enable this plug-in characteristic. Further, all filters 450 may utilize parameters 454, so a single gesture tool as described below may be used to debug and tune the entire filter system. These parameters 454 may be tuned for an application or a context of an application by a gesture tool.

There are a variety of outputs that may be associated with the gesture. In one example, there may be a baseline “yes or no” as to whether a gesture is occurring. In another example, there may be a confidence level, which corresponds to the likelihood that the user's tracked movement corresponds to the gesture. This could be a linear scale that ranges over floating point numbers between 0 and 1, inclusive. Where an application receiving this gesture information cannot accept false-positives as input, it may use only those recognized gestures that have a high confidence level, such as at least 0.95, for example. Where an application must recognize every instance of the gesture, even at the cost of false-positives, it may use gestures that have at least a much lower confidence level, such as those merely greater than 0.2, for example. The gesture may have an output for the time between the two most recent steps, and where only a first step has been registered, this may be set to a reserved value, such as −1 (since the time between any two steps must be positive). The gesture may also have an output for the highest thigh angle reached during the most recent step.

A gesture or a portion thereof may have as a parameter a volume of space in which it must occur. This volume of space may typically be expressed in relation to the body where a gesture comprises body movement. For instance, a football throwing gesture for a right-handed user may be recognized only in the volume of space no lower than the right shoulder 410a, and on the same side of the head 422 as the throwing arm 402a-410a. It may not be necessary to define all bounds of a volume, such as with this throwing gesture, where an outer bound away from the body is left undefined, and the volume extends out indefinitely, or to the edge of capture area that is being monitored.

FIGS. 9A-9B depicts more complex gestures or filters 450 created from stacked gestures or filters. Gestures can stack on each other. That is, more than one gesture may be expressed by a user at a single time. For instance, rather than disallowing any input but a throw when a throwing gesture is made, or requiring that a user remain motionless save for the components of the gesture (e.g. stand still while making a throwing gesture that involves only one arm). Where gestures stack, a user may make a jumping gesture and a throwing gesture simultaneously, and both of these gestures will be recognized by the gesture engine.

FIG. 9A depicts a simple gesture filter 450 according to the stacking paradigm. The IFilter filter 502 is a basic filter that may be used in every gesture filter. IFilter 502 takes user position data 504 and outputs a confidence level 506 that a gesture has occurred. It also feeds that position data 504 into a SteeringWheel filter 508 that takes it as an input and outputs an angle to which the user is steering (e.g. 40 degrees to the right of the user's current bearing) 510.

FIG. 9B depicts a more complex gesture that stacks filters 450 onto the gesture filter of FIG. 9A. In addition to IFilter 502 and SteeringWheel 508, there is an ITracking filter 512 that receives position data 504 from IFilter 502 and outputs the amount of progress the user has made through a gesture 518. ITracking 512 also feeds position data 504 to GreaseLightning 516 and EBrake 518, which are filters regarding other gestures that may be made in operating a vehicle, such as using the emergency brake.

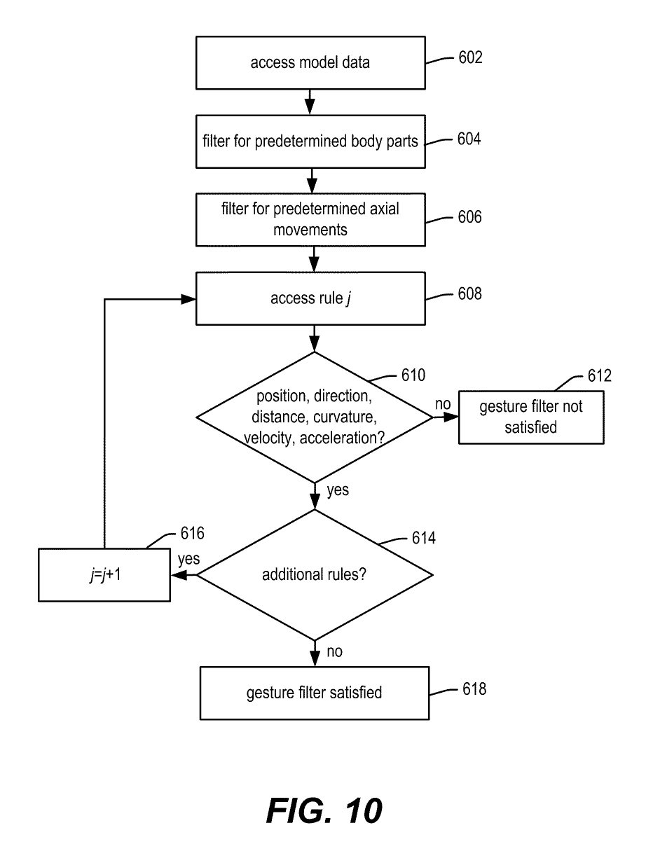

FIG. 10 is a flowchart describing one embodiment of a process for gesture recognition in accordance with an embodiment of the present disclosure. FIG. 10 describes a rule based approach for applying one or more gesture filters by the gesture recognition engine 190 to determine whether a particular gesture's parameters were satisfied. It will be appreciated that the process of FIG. 10 may be performed multiple times to detect multiple gestures in the active gesture set although detection of a single gesture is described in the particular example. The described process may be performed in parallel or in sequence for multiple active gestures.

At step 602, the gesture recognition engine accesses the skeletal tracking data for a particular target to begin determining whether that target has performed a selected gesture. The skeletal tracking data can be accessed from a motion capture file in one example. At step 604, the gesture recognition engine filters the skeletal tracking data for one or more predetermined body parts pertinent to the selected gesture as identified in the selected gesture filter. Step 604 can include accessing only that data which is pertinent to the selected gesture, or accessing all skeletal tracking data for the target and ignoring or discarding information not pertinent to the selected gesture. For example, a hand press gesture (described below) filter may indicate that only a human target's hand is pertinent to the selected gesture such that data pertaining to other body parts can be ignored. Such a technique can increase the performance of the gesture recognition engine by limiting processing to that information predetermined to be salient to the selected gesture.

At step 606, the gesture recognition engine filters the skeletal tracking data for predetermined axial movements. The selected gesture's filter may specify that only movements along a subset of axes are relevant. Consider a vertical fling gesture as will be described in more detail hereinafter in which a user moves their hand up or down in the vertical direction to control the user interface. The gesture filter for the vertical fling gesture may specify that the only relevant axial movement is that along the vertical Y-axis and that movements along the horizontal X-axis and the depth Z-axis are not relevant. Thus, step 606 can include accessing the skeletal tracking data for a target's hand movement in the vertical Y-axis direction and ignoring or discarding data pertaining to the hand's movement in the X-axis or Z-axis direction. It is noted that in other examples a vertical fling gesture filter may specify examination of a hand's movement in other directions as well. For example, horizontal X-axis movements may be analyzed to determine which item(s) on the screen are to be manipulated by the vertical fling gesture.

At step 608, the gesture recognition engine accesses a rule j specified in the gesture filter. In the first iteration through the process of FIG. 10, j is equal to 1. A gesture may include a plurality of parameters that need to be satisfied in order for the gesture to be recognized. Each one of these parameters can be specified in a separate rule, although multiple components can be included in a single rule. A rule may specify a threshold distance, position, direction, curvature, velocity and/or acceleration, among other parameters, that a target's body part must meet in order for the gesture to be satisfied. A rule may apply to one body part or multiple body parts. Moreover, a rule may specify a single parameter such as position or multiple parameters such as position, direction, distance, curvature, velocity and acceleration.

At step 610, the gesture recognition engine compares the skeletal tracking data filtered at steps 604 and 606 with the specified parameter(s) of the rule to determine whether the rule is satisfied. For example, the gesture recognition engine may determine whether a hand's starting position was within a threshold distance of a starting position parameter. The rule may further specify and the engine determine whether the hand: moved in a specified direction; moved a threshold distance from the starting position in the specified direction; moved within a threshold curvature along a specified axis; moved at or above a specified velocity; reached or exceeded a specified acceleration. If the engine determines that the skeletal tracking information does not meet the parameters specified in the filter rule, the engine returns a fail or gesture filter not satisfied response at step 612. The response may be returned to operating system 196 or an application executing on computing system 12.

At step 614 the gesture recognition engine determines whether the gesture filter specifies additional rules that must be met for the gesture to be completed. If additional rules are included in the filter, j is incremented by one and the process returns to step 608 where the next rule is accessed. If there are no additional rules, the gesture recognition engine returns an indication that the gesture filter has been satisfied at step 618.

Steps 612 and 618 of FIG. 10 return a simple pass/fail response for the gesture being analyzed. In other examples, rather than return a simple pass/fail response, FIG. 10 will return a confidence level that the gesture's filter was satisfied. For each rule in the filter, an amount by which the target's movement meets or does not meet a specified parameter is determined. Based on an aggregation of these amounts, the recognition engine returns a confidence level that the gesture was indeed performed by the target.

An exemplary set of gestures in accordance with the presently disclosed technology is now described. Although specific gestures, filter parameters and corresponding system actions to take upon gesture detection are described, it will be appreciated that other gestures, parameters and actions may be utilized within tracking system 10 in other embodiments.

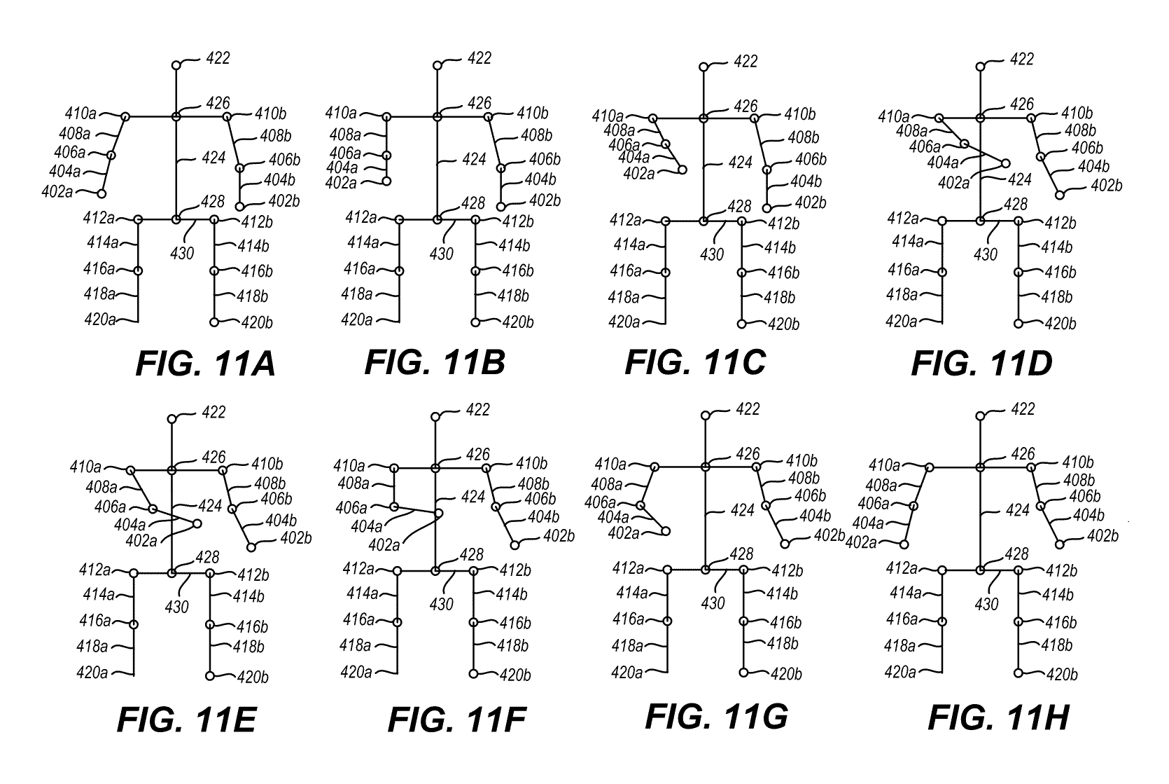

FIGS. 11A through 11H depict a skeletal mapping of a human target performing a horizontal fling gesture in accordance with one embodiment. The skeletal mapping depicts the user at points in time, with FIG. 11A being a first point in time and FIG. 11H being a last point in time. Each of the Figures may correspond to a snapshot or frame of image data as captured by a depth camera. They are not necessarily consecutive frames of image data as the depth camera may be able to capture frames more rapidly than the user may cover the distance. For instance, this gesture may occur over a period of three seconds and where a depth camera captures data at 30 frames per second, it will require 90 frames of image data while the user made this fling gesture. In this example, a variety of joints and bones are identified: each hand 402, each forearm 404, each elbow 406, each bicep 408, each shoulder 410, each hip 412, each thigh 414, each knee 416, each foreleg 418, each foot 420, the head 422, the torso 424, the top 426 and bottom 428 of the spine, and the waist 430. Where more points are tracked, additional features may be identified, such as the bones and joints of the fingers or toes, or individual features of the face, such as the nose and eyes.

In FIG. 11A, the user begins with both arms at his sides. The user begins moving his right hand 402a along the horizontal X-axis toward the left side of his body as depicted in FIG. 11B. In FIG. 11B, the user's right arm (408a-402a) is aligned in the horizontal X-axis direction with the user's right shoulder 410a. The user has further lifted his right arm vertically along the Y-axis. The user continues to move his right arm horizontally along the X-axis towards the left side of his body while further raising his arm along the Y-axis vertically with respect to the floor or his feet 420a, 420b. Although not visible in the two dimensional representation of FIGS. 11A through 11H, it will be appreciated that by raising the right arm vertically, the user is extending his right arm toward the capture device, or along the Z-axis by extending his right arm from beside his body to in front of his body. The user completes the horizontal fling gesture as shown in FIG. 11D when his right hand reaches the furthest distance it will travel along the horizontal axis in the X direction towards the left portion of his body.

FIGS. 11E through 11H depict the return motion by the user in bringing his right arm back to the starting position. The first portion of the return movement, indicated in FIG. 11E, typically involves a user pulling the bicep 408a of their right arm towards the right side of their body. Further, this motion generally involves the user's right elbow 406a being lowered vertically along the Y-axis. In FIG. 11F, the user has further moved his right arm towards the right side of his body to a point where the bicep portion 408a of the right arm is substantially aligned with the right shoulder 410a in the horizontal direction. In FIG. 11F, the user has further pulled the right arm towards the right side of his body and has begun straightening the arm at the elbow joint 406a, causing the forearm portion of the right arm to extend along the Z-axis towards the capture device. In FIG. 11H, the user has returned to the starting position with his right arm nearing a straightened position between shoulder 410a and hand 402a at the right side of his body.

While the capture device captures a series of still images such that at any one image the user appears to be stationary, the user is moving in the course of performing this gesture as opposed to a stationary gesture. The system is able to take this series of poses in each still image and from that determine the confidence level of the moving gesture that the user is making.

The gesture filter for the horizontal fling gesture depicted in FIGS. 11A through 11H may set forth a number of rules defining the salient features of the horizontal fling gesture to properly detect such a motion by the user. In one example, the horizontal fling gesture is interpreted as a handed gesture by the capture device. A handed gesture is one in which the filter defines the gesture's performance as being made by a particular hand. The gesture filter in one example may specify that only movement by the right hand is to be considered, such that movement by the left arm, hand, legs, torso and head, etc. can be ignored. The filter may specify that the only relevant mapping information to be examined is that of the hand in motion. Movement of the remainder of the target's body can be filtered or ignored, although other definitions of a horizontal fling gesture may specify some movement of other portions of the target's body, for example, that of the target's forearm or bicep.

To detect a horizontal fling gesture, the gesture's filter may specify a starting position parameter, for example, a starting position of the target's hand 402a relative to the target's body. Because the target may often be in relatively continuous motion, the gesture recognition engine may continuously look for the hand at the starting position, and then subsequent movement as detailed in FIGS. 11B-11D and specified in additional parameters described below.

The horizontal fling gesture filter may specify a distance parameter for the right hand 402a. The distance parameter may require that the right hand move a threshold distance from the right side of the user's body to the left side of the user's body. In one example, the horizontal fling gesture filter will specify that vertical movements along the Y-axis are to be ignored. In another example, however, the horizontal fling gesture filter may specify a maximum distance that the right hand may traverse vertically so as to distinguish other horizontal movements that may involve a vertical component as well. In one example, the horizontal fling gesture filter further specifies a minimum velocity parameter, requiring that the hand meet a specified velocity in its movement from the right side of the user's body to the left side of the user's body. In another example, the gesture filter can specify a time parameter, requiring that the hand travel the threshold distance within a maximum amount of time.

In general, the system will look for a number of continuous frames in which the user's movement matches that specified in the gesture filter. A running history of the target's motion will be examined for uninterrupted motion in accordance with the filter parameters. For example, if the movements indicated in FIGS. 11A-11D are interrupted by movement outside of the specified motion, the gesture filter may not be satisfied, even if the frames before and after the interruption match the movement specified in the filter. Where the capture system captures these positions by the user without any intervening position that may signal that the gesture is canceled or another gesture is being made, the tracking system may have the horizontal fling gesture output a high confidence level that the user made the horizontal fling gesture.

The horizontal fling gesture filter may include metadata that specifies velocity ranges of the hand in performing the horizontal fling gesture. The computing environment can use the velocity of the hand in traveling towards the left side of the body to determine an amount by which the system will respond to the fling gesture. For example, if the fling gesture is being used to scroll items horizontally on a list, the items may scroll more quickly in response to higher velocity movements and more slowly in response to slower velocity movements. In addition to or alternatively, the metadata can specify velocity ranges whereby the number of items scrolled is increased based on higher velocity gesture movement and decreased for lower velocity gesture movement.

The horizontal fling gesture filter may also include metadata that specifies distance ranges of the hand in performing the horizontal fling gesture. The computing environment can use the distance traveled by the hand to determine an amount by which the system will respond to the fling gesture. For example, if the fling gesture is being used to scroll items horizontally on a list, the list may scroll by a larger amount in response to larger distances traveled by the hand and by a smaller amount in response to smaller distances traveled by the hand.

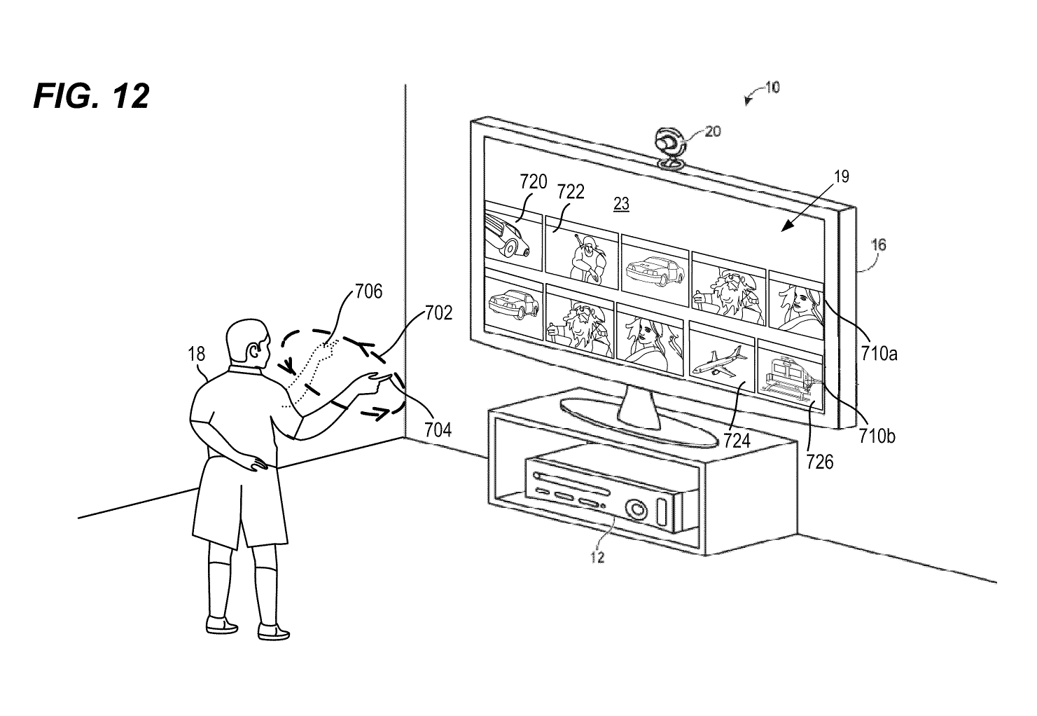

FIG. 12 depicts user 18 interacting with the tracking system 10 to perform a horizontal fling gesture as described in FIGS. 11A-11H. Dotted line 702 indicates the direction of the user's right hand 402a in performing the horizontal fling gesture. As depicted, the user begins with his right hand 402a in position 704, then moves it to position 706 toward the left side of his body, then returns it to position 704. This movement may be repeated multiple times to scroll through a list 710 of menu items such as those shown on audio-visual device 16 in FIG. 12. The user may move between position 704 and position 706 and back to position 704 a number of times to further scroll the list of items from right to left (as defined by the user's point of view). Reference numeral 710a represents the list of menu items when the user begins the gesture with his hand at position 704. Reference numeral 710b represents the same list of menu items after the user has completed the gesture by moving his right hand to position 706. Items 720 and 722 have scrolled off of the display and items 724 and 726 have scrolled onto the display.

Looking back at FIGS. 11E through 11H and FIG. 12, it can be seen that in performing a horizontal fling gesture, the user returns his right hand from the ending position 706 to the starting position 704. In such instances, the tracking system differentiates the return movement from position 706 to 704 from a possible left-handed horizontal fling gesture so as not to cause the menu items to scroll left to right when the user returns his hand to its starting position. In one example, this is accomplished by defining gestures as handed as noted above. A right-handed fling gesture can be defined by its gesture filter as only being capable of performance by a right hand. In such a case, any movement by the left hand would be ignored. Similarly, a left-handed fling gesture could be defined as a handed gesture such that the tracking system only regards movement by the left hand as being the performance of a left-handed fling gesture. In such a case, the system would identify the movements from position 706 to position 704 as being performed by the right hand. Because they are not performed by the left hand the system will not interpret them as a left-handed fling gesture. In this manner, a user can move his hand in a circle as illustrated by dotted line 702 to scroll the list of items from the right part of the screen to the left part of the screen without the return movement being interpreted as a left-handed fling gesture causing the items to scroll back from left to right.

Other techniques may be used in place of or in combination with handed gesture definitions to discriminate between a right handed fling gestures return to the starting position and an intended left hand fling gesture. Looking again at FIG. 12, dotted line 702 shows that the right hand moves back and forth along the Z-axis (toward and away from the capture device) in the course of performing the gesture and its return. The user extends his right hand out in front of his body in moving from position 704 to position 706, but tends to retract the hand back towards the body in returning from position 706 to 704. The system can analyze the Z-values of the right-handed movement and determine that the hand when moving from 704 to 706 is extended towards the capture device but during the return motion is pulled back from the capture device. The gesture filter can define a minimum extension of the hand from the body as a required position parameter for defining a right-handed fling gesture by setting the minimum distance from the user's body. Within the circle as shown, the movement in returning the hand from position 706 to 704 will be ignored as not meeting the required Z-value for extension of the hand from the body. In this manner, the system will not interpret the return movement as a horizontal fling gesture to the right.

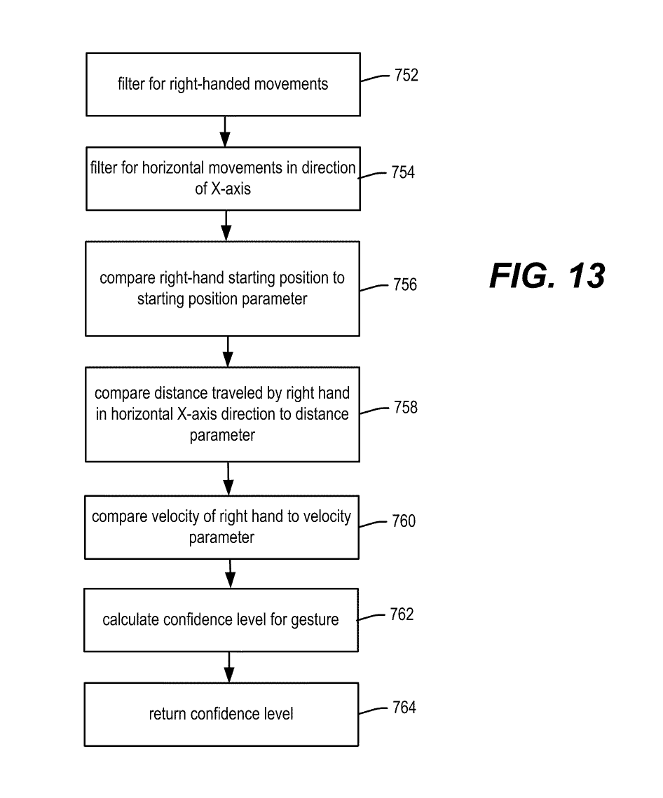

FIG. 13 is a flowchart describing a gesture recognition engine applying a right-handed fling gesture filter to a target's movement in accordance with one embodiment. At step 752, the gesture recognition engine filters for right-handed movement. In this particular example, the right-handed fling gesture is defined as handed such that left hand movements are ignored, although it will be understood that other techniques, such as examining Z-axis movement, could be used to differentiate the gesture from its return movement. At step 754, the engine filters for horizontal movement along the X-axis, discarding or ignoring data pertaining to vertical movements along the Y-axis or depth movements along the Z-axis. At step 756, the engine compares the right hand's starting position to a starting position parameter. Step 756 may include determining whether the right hand's starting position is within a threshold distance of a specified starting position, defined relative to the user's body. Step 756 may include determining a difference between the actual starting position and starting position parameter that will be used in determining a confidence level that the movement is a right-handed fling gesture.

At step 758, the engine compares the distance traveled by the right hand in the horizontal direction to a distance parameter. Step 758 may include determining if the actual distance traveled is at or above or threshold distance or may include determining an amount by which the actual distance differs from a distance parameter. Step 758 can include determining the direction of the right-handed movement in one embodiment. In another, a separate comparison of directional movement can be made. At step 760, the engine compares the velocity of the right hand in traversing along the X-axis with a velocity parameter. Step 760 may include determining if the right hand velocity is at or above a threshold level or determining a difference between the actual velocity and a specified velocity parameter.

At step 762, the engine calculates a confidence level that the right-handed movement was a right-handed fling gesture. Step 762 is based on the comparisons of steps 756-758. In one embodiment, step 762 aggregates the calculated differences to assess an overall likelihood that the user intended their movements as a right-handed fling gesture. At step 764, the engine returns the confidence level to operating system 196 or an application executing on computing system 12. The system will use the confidence level to determine whether to apply a predetermined action corresponding to the gesture to the system user-interface.

In FIG. 13, the engine returns a confidence level that the gesture was performed, but it will be appreciated that the engine alternatively may report a simple pass or fail as to whether the gesture was performed. Additional parameters may also be considered. For example, vertical movements could be considered in an alternate embodiment to distinguish other user movement or gestures. For example, a maximum vertical distance parameter could be applied such that vertical movement beyond the parameter distance will indicate the horizontal fling gesture was not performed. Further, movement in the direction of the Z-axis may be examined so as to differentiate the right-hand fling gesture's return movement from that of a left-handed fling gesture.

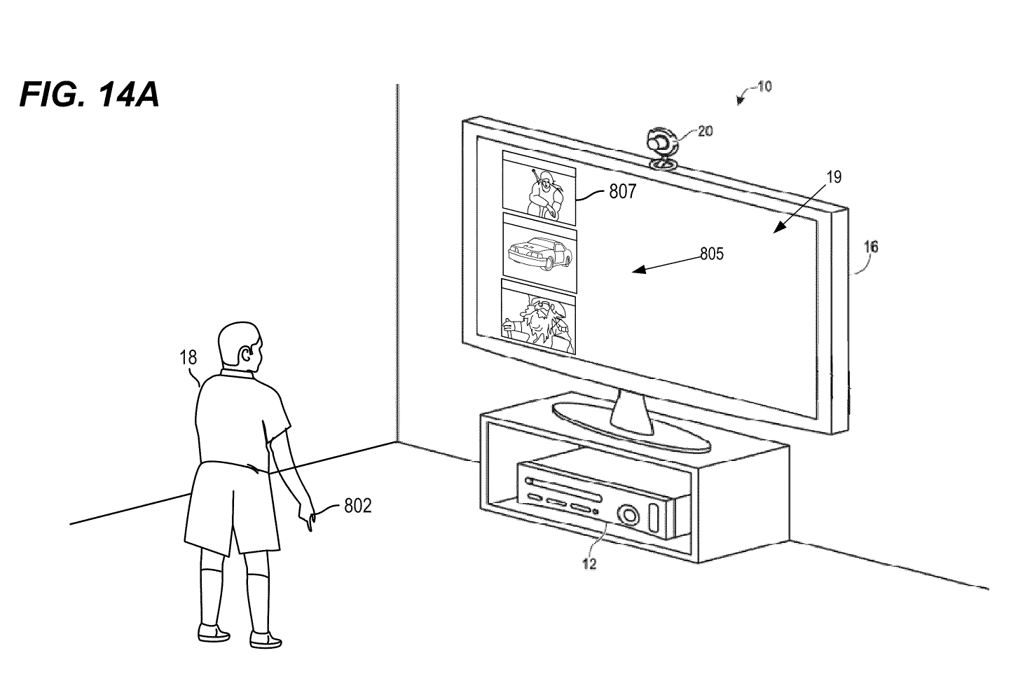

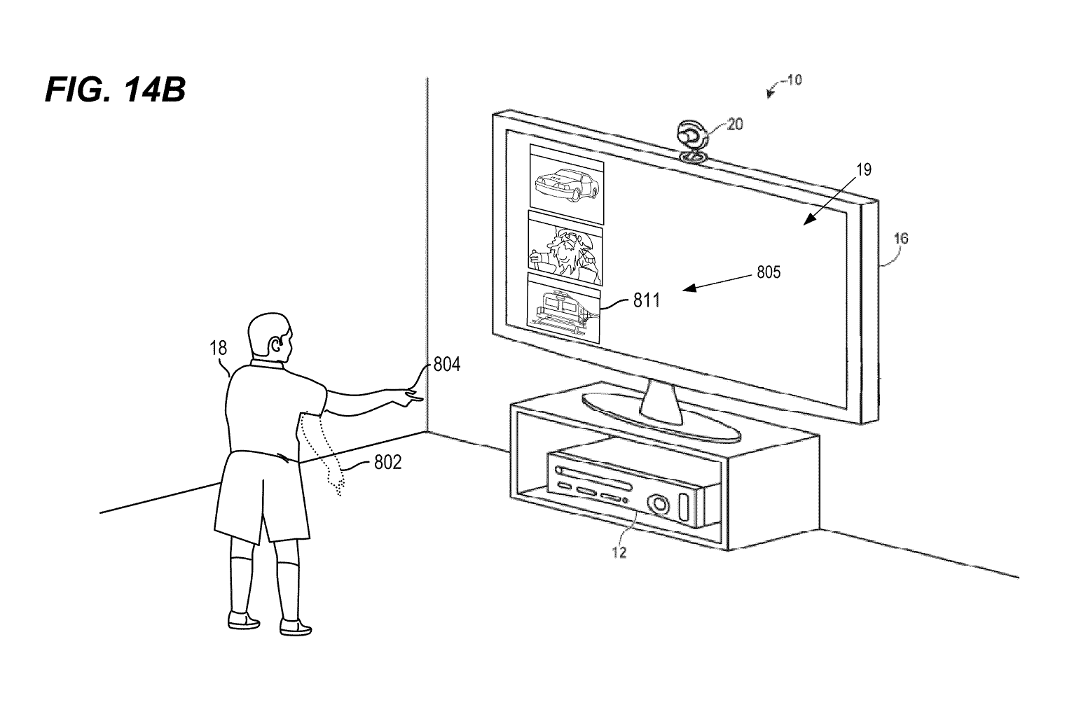

FIGS. 14A and 14B depict user 18 interacting with tracking system 10 to perform a vertical fling gesture. As depicted in FIG. 14A, user 18 begins with his right arm at his right side and extended outward toward the capture device. The user's arm begins in position 802. Audio-visual device 16 has displayed thereon user-interface 19 with a list 805 of menu items aligned vertically.

In FIG. 14B the user has moved his right arm and hand from starting position 802 to ending position 804. The right hand is lifted vertically from a position below the user's waist to a position near alignment with the user's right shoulder in the vertical Y-axis direction. The user has also extended his right hand along the Z-axis from a point near to his body to a position out in front of his body.

The gesture recognition engine utilizes a gesture filter to assess whether the movement meets the parameters defining a vertical fling gesture filter. In one example, the vertical fling gesture is handed, meaning that a right-handed vertical fling gesture is differentiated from a left-handed vertical fling gesture based on identification of the hand that is moving. In another example, the vertical fling gesture is not handed, meaning that any hand's movement meeting the specified parameters will be interpreted as a vertical fling gesture.

The gesture filter for a vertical fling gesture may specify a starting hand position as below the target's waist. In another example, the starting position may be defined as below the user's shoulder. The filter may further define the starting position as having a maximum position in the vertical direction with respect to the user's body position. That is, the hand must begin no more than a specified distance above a particular point on the user's body such as the user's foot. The maximum starting position may also be defined relative to the shoulder or any other body part. For example, the filter may specify that the user's hand in the vertical direction must be a minimum distance away from the user's shoulder. The filter may further specify a minimum distance the hand must travel in the vertical direction in order to satisfy the filter. Like the horizontal fling gesture, the filter may specify a minimum velocity that the hand must reach and/or acceleration. The filter may further specify that horizontal movements along the X-axis are to be ignored. In another embodiment, however, the filter may constrain horizontal movements to some maximum allowable movement in order to distinguish other viable gestures. The velocity and/or acceleration of the target's hand may further be considered such that the hand must meet a minimum velocity and/or acceleration to be regarded as a vertical fling gesture.

FIG. 14B depicts the user-interface action that is performed in response to detecting the vertical fling gesture. The user-interface 19 list 805 of menu items has been scrolled upwards such that item 807 is no longer displayed, and item 811 has been added to the display at the lower portion of the display.

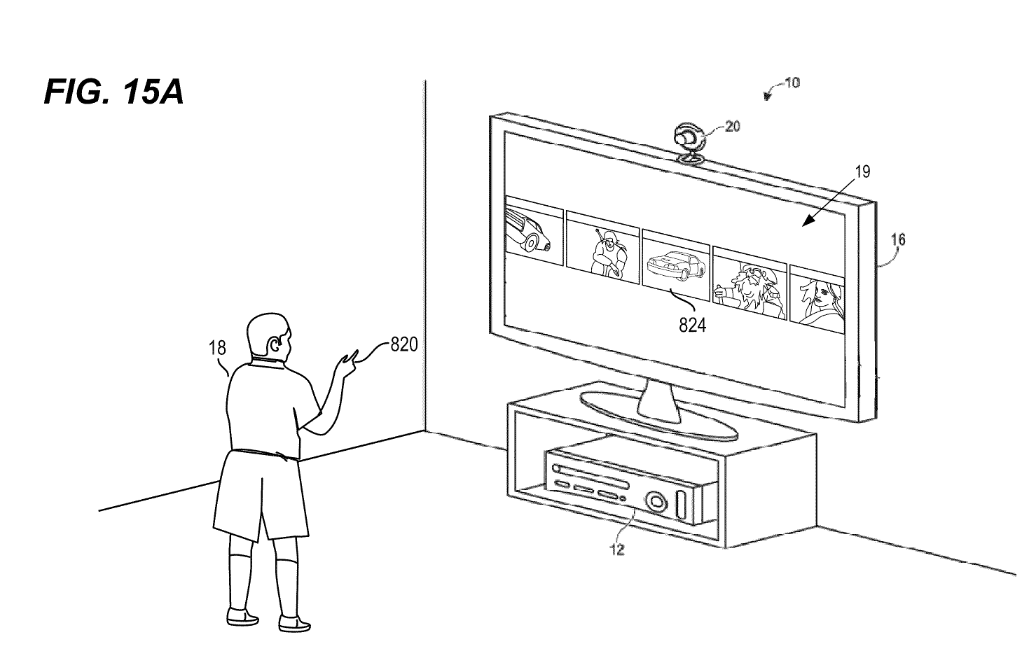

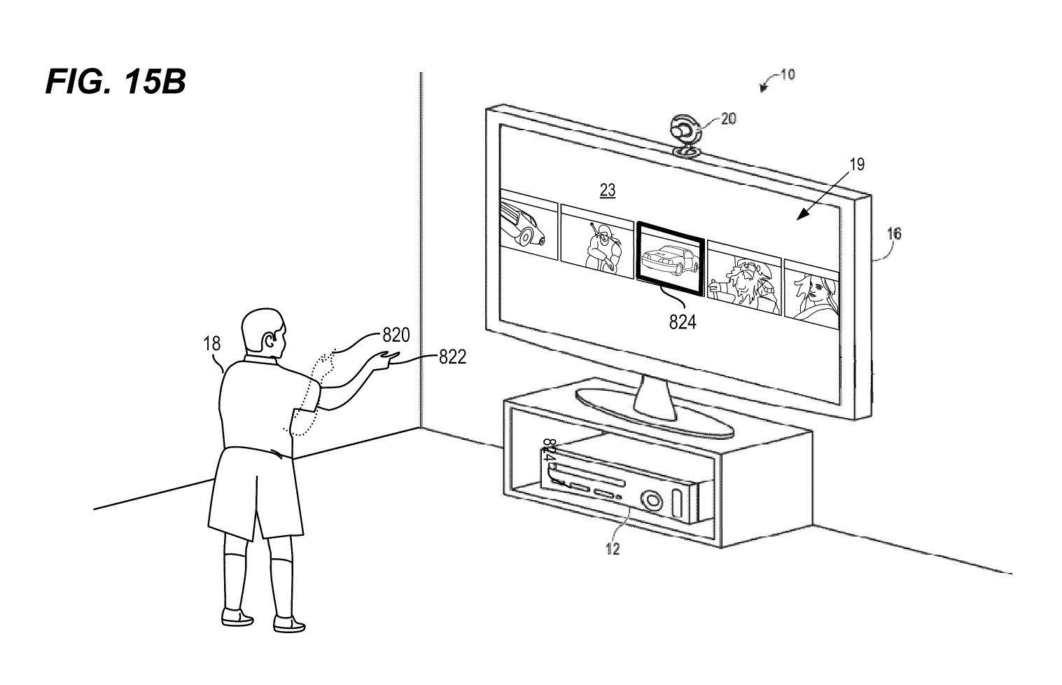

FIGS. 15A-15B depict user 18 interacting with tracking system 10 to perform a press gesture. A press gesture can be used by a user to select items on the display. This action may traditionally be performed using a mouse or directional pad to position a cursor or other selector above an item and then to provide an input such as by clicking a button to indicate that an item is selected. A midair press gesture can be performed by a user pointing to a particular item on the screen as FIGS. 15A and 15B demonstrate. In FIG. 15A the user begins with his hand at about shoulder level in the vertical Y-axis direction and extended out in front of the user some distance in the depth Z-axis direction toward the capture device. In the horizontal X-axis direction, the user's hand is substantially aligned with the shoulder. The horizontal direction starting position may not be specified within the filter as a required parameter such that horizontal movements may be ignored in one embodiment. In another embodiment, horizontal position and movement may be considered to distinguish other viable gestures. Looking at FIG. 15B, the user extends his arm from starting position 820 to ending position 822. The user's hand moves along the Z-axis away from the body and towards the capture device. In this example, the user's hand makes little or no movement along the vertical Y-axis and no movement horizontally along the X-axis. The system interprets the movement from position 820 to 822 as comprising a press gesture. In one embodiment, the capture device in computing environment 12 uses the starting position of the user's hand 822 in XY space to determine the item on the displayed user interface that has been selected. In another embodiment, the capture device determines the final position of the user's hand to determine the selected item. The two positions can also be used together to determine the selected item. In this case, the user has pointed to item 824 thereby highlighting it as illustrated in FIG. 15B.

The filter for a press gesture may define a vertical starting position for the hand. For instance, a parameter may specify that the user's hand must be within a threshold distance of the user's shoulder in the vertical direction. However, other press gesture filters may not include a vertical starting position such that the user can press with his arm or hand at any point relative to his shoulder. The press gesture filter may further specify a starting position of the hand in the horizontal X-axis direction and/or the Z-axis direction towards the capture device. For example, the filter may specify a maximum distance of the hand from the corresponding shoulder in the X-axis direction and a maximum distance away from the body along the Z-axis direction. The filter may further specify a minimum threshold distance that the hand must travel from starting position 820 to ending position 822. Further, the system may specify a minimum velocity that the hand must reach in making this movement and/or a minimum acceleration that the hand must undergo in making this movement.

In one example, press gestures are not handed such that the system will use a single gesture filter to identify press gestures by the right hand or the left hand. The filter may just specify that a hand must perform the movement and not that it's a particular hand. In another example, the press gesture can be handed such that a first filter will look for pressing movements by a right hand and a second filter will look for pressing movements by a left hand. The gesture filter may further specify a maximum amount of vertical displacement in making the movement from 820 to 822 such that if the hand travels too much along the Y-axis, the movement can be ignored as meeting the vertical fling gesture criteria.

Although not depicted, the reverse of the press gesture depicted in FIGS. 15A and 15B, can be defined as a back gesture in one embodiment. A filter can essentially describe the reverse movement of the press gesture described in FIGS. 15A and 15B. A user may begin with his hand out in front of his body and move his hand towards his body which will be interpreted by the tracking system as a back gesture. The UI could interpret this movement and move backwards in the current user interface in one embodiment. In another embodiment, such a movement could cause zooming out or abstraction of the current menu display.

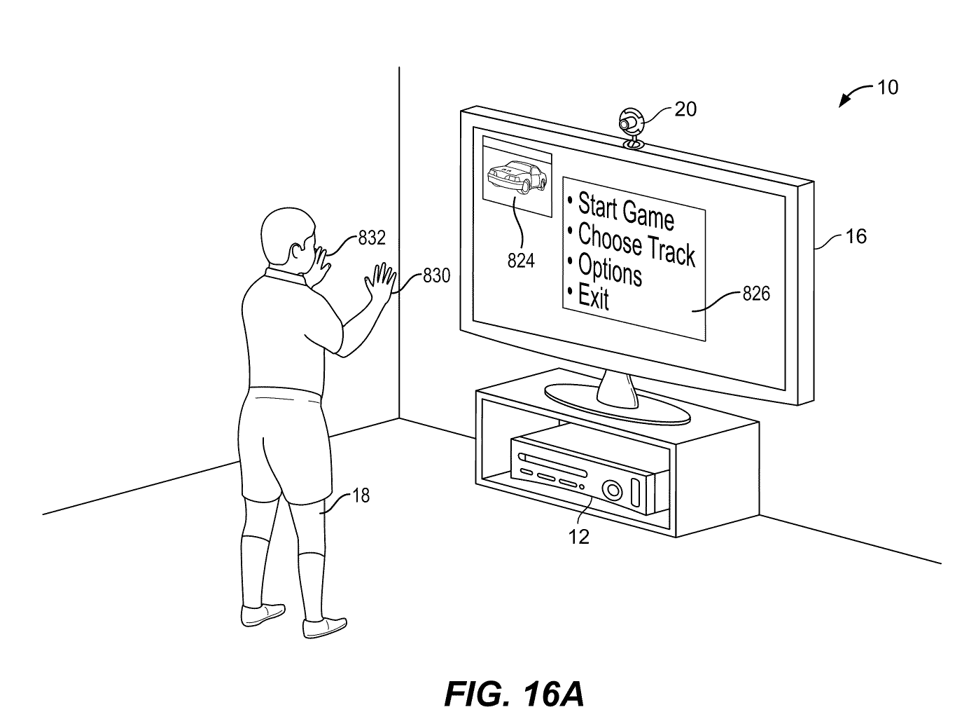

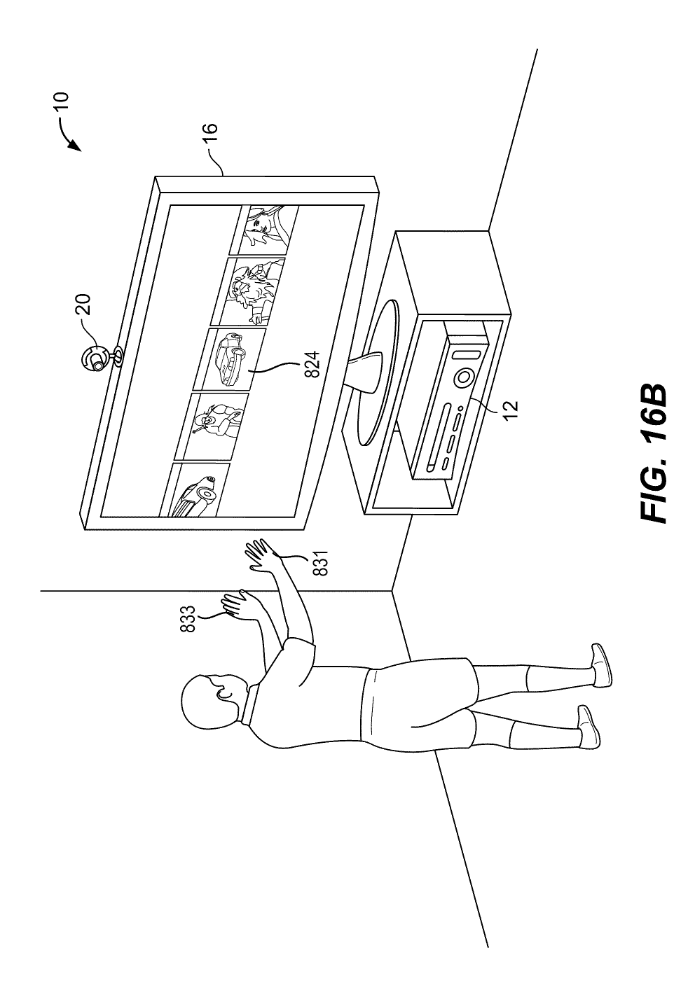

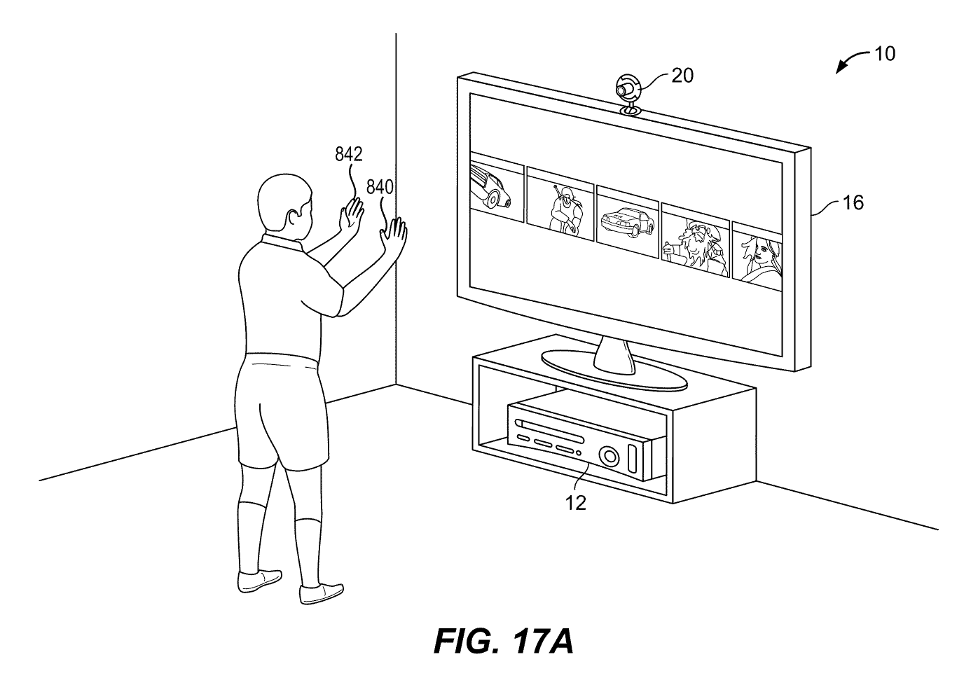

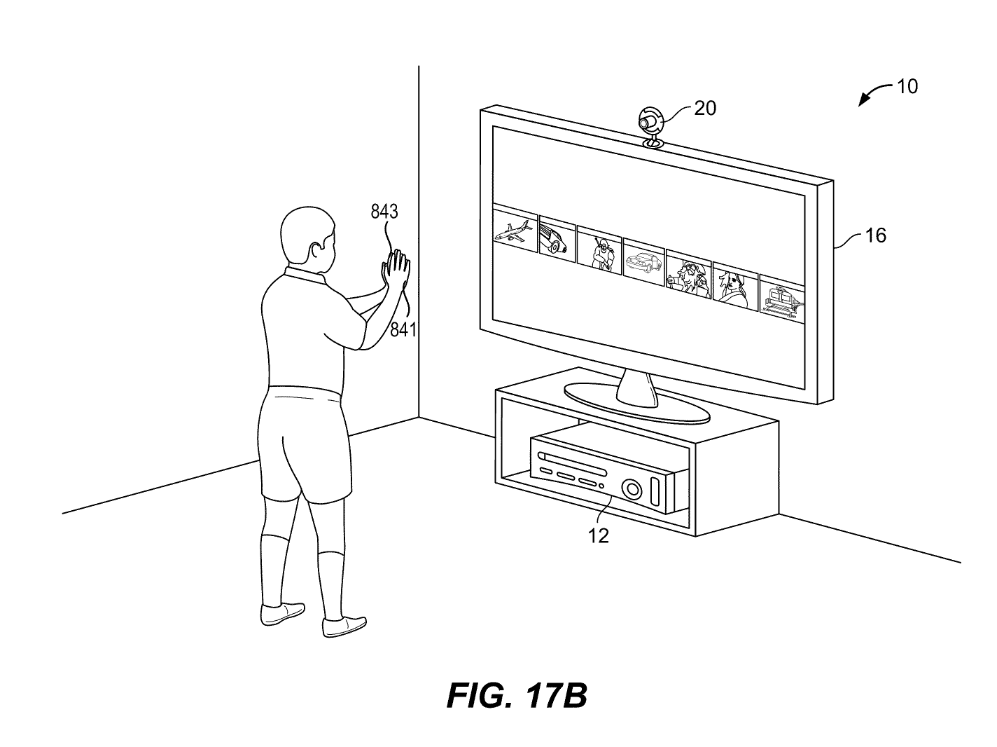

FIGS. 16A and 16B depict user 18 interacting with tracking system 10 to perform a two-handed press gesture. In the particularly described example, the two-handed press gesture is used to move backwards in the user interface. That is the user interface may be organized in a hierarchical fashion such that by utilizing a two handed press gesture, the user moves from a particular menu up the hierarchical tree to a higher level menu. In another example (not depicted), a two handed press gesture could be used to zoom out of the current user-interface. By pressing towards the screen with two hands, the user interface will zoom from a first level to a higher level, for example, as will be described hereinafter in FIGS. 17A and 17B.

In FIG. 16A the user begins with both hands at about shoulder height in front of their body and substantially aligned in the horizontal direction with the shoulders. The user's arms between shoulder and elbow extend downward at an angle and the user's arms from elbow to hand extend upward forming a V-shape. The user interface presents a menu 826 having a number of menu options illustrated with the examples of start game, choose track, options and exit. Looking back at FIGS. 15A and 15B, the menu item depicted in FIG. 16A may correspond to a menu selection for item 824 of FIGS. 15A and 15B after a user has selected the menu for example as in response to the press gesture performed therein.

In FIG. 16B the user has extended both hands along the Z-axis toward the capture device from their starting positions 830, 832 to ending positions 831, 833. The hands in this example have not moved vertically along the Y-axis or horizontally along the X-axis. The user interface in FIG. 16B reverts back to the position as illustrated in FIG. 15B. The user has moved from the more detailed menu options associated with item 824 back to the menu selection screen as illustrated in FIG. 15B. This corresponds to moving up in the hierarchical order of the user interface.

The gesture filter for a two handed press gesture may define a starting position for both hands. In this example the press gesture is not handed in that it requires a combination of both hands so the system will filter for hand movements of the right hand and left hand, together. The filter may specify a vertical starting position for both hands. For example, it may define that the hands must be between the user's waist and head. The filter may further specify a horizontal starting position such that the right hand must be substantially aligned horizontally with the right shoulder and the left hand substantially aligned horizontally with the left shoulder. The filter may also specify a maximum distance away from the user's body along the Z-axis that the hands may be to begin the motion and/or an angular displacement of the user's forearm with respect to the user's bicep. Finally, the filer may define that the two hands must be vertically aligned relative to each other at the beginning of the gesture.

The filter may define a minimum distance parameter that each hand must travel along the Z-axis towards the capture device away from the user's body. In one example, parameters set forth a minimum velocity and/or acceleration each hand must meet while making this movement. The gesture filter for the two handed press gesture may also define that the right hand and left hand must move in concert from their beginning positions to their ending positions. For example, the filter may specify a maximum amount of displacement along the Z-axis between the right hand and the left hand so as to insure that a two handed gesture movement is being performed. Finally, the two handed press gesture may define an ending position for each hand. For example, a distance parameter may define that each hand be a minimum distance away from the user's body at the end of the movement.

Although not depicted, the two handed press gesture has a corresponding two handed back gesture in one embodiment. The filter for this movement could essentially describe the reverse of the movement depicted in FIGS. 16A and 16B. By beginning with the user's hands out in front of his body and pulling them towards his shoulders, the user could cause the user interface to move backwards in the current user interface or to zoom in.

FIGS. 17A and 17B depict user 18 interacting with the tracking system 10 to perform a two handed compression gesture in one embodiment. FIG. 17A depicts user 18 with his right hand and left hand in front of his body at positions 840 and 842, similar to the starting positions in FIG. 16A. In this example, however, the user's palms are facing each other rather than the capture device. The hands are vertically and horizontally aligned with the shoulders and extended some distance away from the user's body along the Z- axis. Looking at FIG. 17B, the user has brought his hands together to ending positions 841 and 843 so that the palms are touching. The user moves his right hand towards his left hand and his left hand towards his right hand so that they meet at some point in between. The hands do not move substantially in the vertical direction along the Y-axis or in the depth direction along the Z-axis.

In response to detecting the two-handed compression gesture, computing system 12 compresses or zooms out of the current user-interface display to show more elements or menu items on the list. In another example, the two handed compression gesture could result in the user interface action as shown in FIGS. 16A and 16B by moving backwards in the user interface from a lower level in the menu hierarchy to a higher level in the menu hierarchy.

In one embodiment, the two handed compression gesture filter can define starting positions for both the right hand and the left hand. In one example, the starting positions can be defined as horizontally in alignment with the user's shoulders, vertically in alignment with the user's shoulders and not exceeding a threshold distance from the user's body in the Z-axis direction. The starting position may not include a vertical position requirement in another example such that the user can bring his hands together at any vertical position to complete the gesture. Likewise, the horizontal position requirement may not be used in one example so that the user can do the compression gesture regardless of where the two hands are horizontally in relation to the user's body. Thus, one example does not include defining a starting position for the user's hands at all. In another example, the user's hands are defined by the filter as being required to be with the palms facing one another. This can include examining other body parts from the scan such as fingers to determine whether the palms are facing. For example, the system may determine whether the thumbs are positioned toward the user's body indicating that the palms are facing each other. The filter may further specify an ending position for both hands such as horizontally being between the user's two shoulders. In another example, the ending position can be defined as the right hand and left hand meeting regardless of their horizontal position with respect to the user's body. In another example, the filter may define a minimum amount of distance that each hand must travel in the horizontal direction. Moreover, the filter could specify a maximum distance that the hands can travel vertically and/or in the Z direction.

Although not shown, a corresponding two handed compression gesture of one embodiment includes a two-handed reverse compression gesture that begins with the hands in the position of FIG. 17B and ending with the hands in the position of FIG. 17A. The filter can essentially define the reverse of the movement depicted in FIGS. 17A and 17B. In this example, by bringing a user's hands apart, the user may zoom in on the current display, for example causing the UI to change from that depicted in FIG. 17B to FIG. 17A.

Embodiments of the present technology can further use on-screen handles to control interaction between a user and on-screen objects. In embodiments, handles are UI objects for interacting with, navigating about, and controlling a human-computer interface. In embodiments, a handle provides an explicit engagement point with an action area such as an object on the UI, and provides affordances as to how a user may interact with that object. Once a user has engaged a handle, the user may manipulate the handle, for example by moving the handle or performing one or more gestures associated with that handle. In one embodiment, a gesture is only recognized after a user engages a handle.

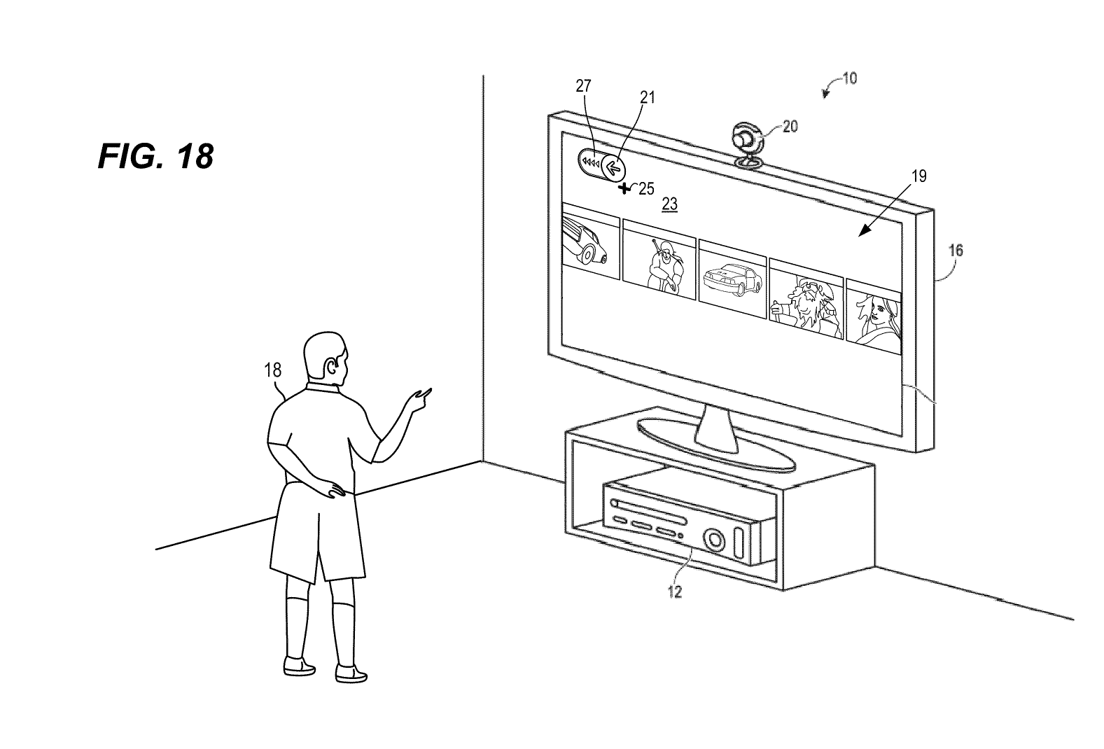

As shown in FIG. 18, in an example embodiment, the application executing on the computing environment 12 may present a UI 19 to the user 18. The UI may be part of a gaming application or platform, and in embodiments may be a navigation menu for accessing selected areas of the gaming application or platform. The computing environment 12 generates one or more handles 21 on the UI 19, each tied to or otherwise associated with an action area 23 on the UI 19. Each handle is in general a graphical object displayed on screen for controlling operations with respect to its associated action area, as explained in greater detail below.

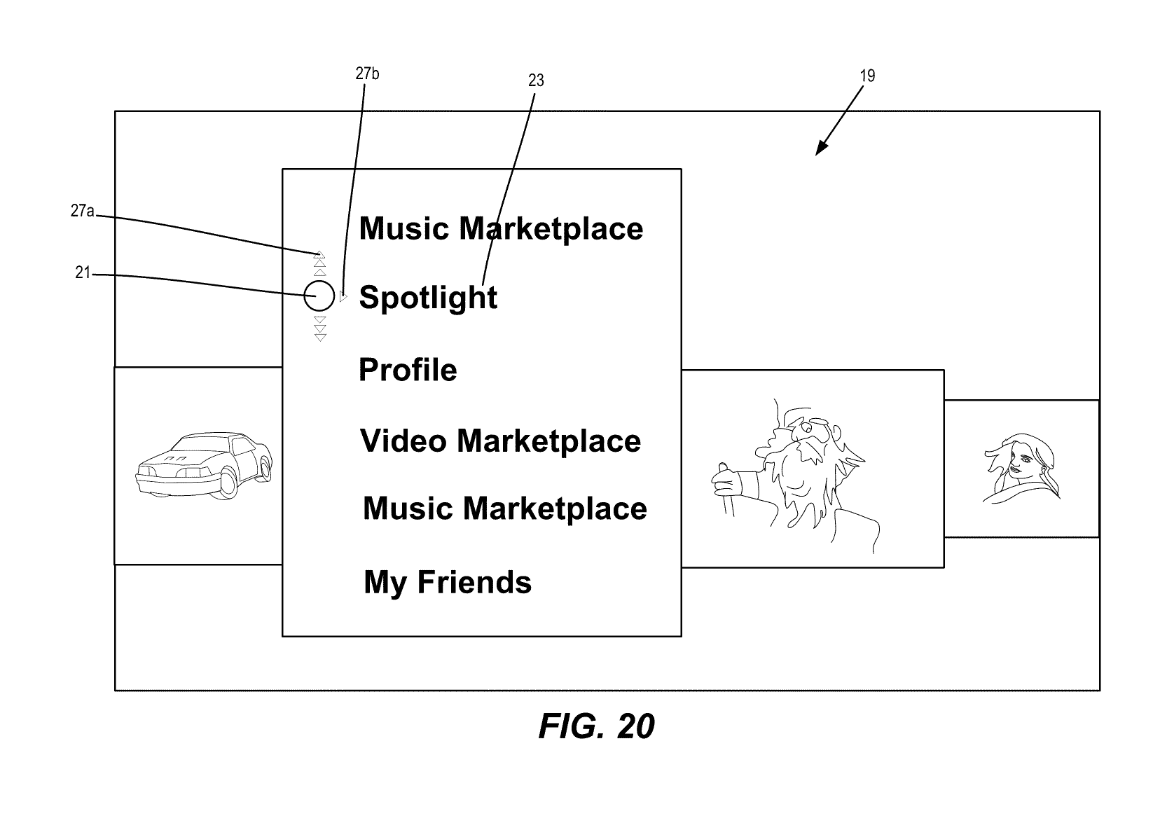

In embodiments, a handle 21 may be shaped as a circle or a three-dimensional sphere on the display, but those of skill in the art would appreciate that a handle may be any of a variety of other shapes in alternative embodiments. As explained below, the presence and appearance of a handle 21 may change, depending on whether a user is present, and depending on whether a user is engaging a handle. In embodiments, the shape of a handle may be the same in all action areas 23, but it is contemplated that different action areas have different shaped handles in further embodiments. While FIG. 20 shows a single handle 21, a UI 19 may include multiple handles 21, each associated with a different action area 23.

An “action area” as used herein is any area on the UI 19 which may have a handle associated therewith, and which is capable of either performing an action upon manipulation of its handle, or which is capable of having an action performed on it upon manipulation of its handle. In embodiments, an action area 23 may be a text or graphical object displayed as part of a navigation menu. However, in embodiments, an action area 23 need not be part of a navigation menu, and need not be a specific displayed graphical object. An action area 23 may alternatively be an area of the UI which, when accessed through its handle, causes some action to be performed, either at that area or on the UI in general.

Where an action area is a specific graphical object on the display, a handle 21 associated with that graphical object may be displayed on the graphical object, or adjacent the graphical object, at any location around the periphery of the graphical object. In a further embodiment, the handle 21 may not be mapped to a specific object. In this embodiment, the action area 23 may be an area on the UI 19 including a number of graphical objects. When the handle 21 associated with that action area is manipulated, an action may be performed on all objects in that action area 23. In a further embodiment, the handle 21 may be integrated into a graphical object. In such an embodiment, there is no visual display of a handle 21 separate from the object. Rather, when the object is grasped or otherwise selected, the object acts as a handle 21, and the actions associated with a handle are performed. These actions are described in greater detail below.

The interface 19 may further include a cursor 25 that is controlled via user movements. In particular, the capture device 20 captures where the user is pointing, as explained below, and the computing environment interprets this image data to display the cursor 25 at the determined spot on the audiovisual device 16. The cursor may provide the user with closed-loop feedback as to where specifically on the audiovisual device 16 the user is pointing. This facilitates selection of handles on the audiovisual device 16 as explained hereinafter. Similarly, each handle may have an attractive force, analogous to a magnetic field, for drawing a cursor to a handle when the cursor is close enough to a handle. This feature is also explained in greater detail hereinafter. The cursor 25 may be visible all the time, only when a user is present in the field of view, or only when the user is tracking to a specific object on the display.

One purpose of a handle 21 is to provide an explicit engagement point from which a user is able to interact with an action area 23 for providing a gesture. In operation, a user would guide a cursor 25 over to a handle 21, and perform a gesture to attach to the handle. The three dimensional real space in which the user moves may be defined as a frame of reference in which the z-axis is an axis extending horizontally straight out from the capture device 20, the x-axis is a horizontal axis perpendicular to the z-axis, and the y-axis is a vertical axis perpendicular to the z-axis. Given this frame of reference, a user may attach to a handle by moving his or her hand in an x-y plane to position the cursor over a handle, and then moving that hand along the z-axis toward the capture device. Where a cursor is positioned over a handle, the computing environment 12 interprets the inward movement of the user's hand (i.e., along the z-axis, closer to an onscreen handle 21) as the user attempting to attach to a handle, and the computing environment performs this action. In embodiments, x-y movement onscreen is accomplished in a curved coordinate space. That is, the user's movements are still primarily in the x-direction and y-direction, but some amount of z-direction warping is factored in to account for the curved path a human arms follow.

There are different types of handles with varying methods of engagement. A first handle may be a single-handed handle. These types of handles may be engaged by either the user's right or left hand, but not both. A second type of handle may be a dual-handed handle. These types of handles are able to be engaged by a user's right hand or left hand. Separate instances of dual-handed handles may be created for right and left hand versions, and positioned to the left or right of an action area, so that the handle can be positioned for more natural engagement in 3D space for a user. A third type of handle is a two-handed paired handle. These handles require both of a user's hands to complete an interaction. These interactions utilize visual and, in embodiments, auditory affordances to inform a user how to complete the more complex interactions as explained below.

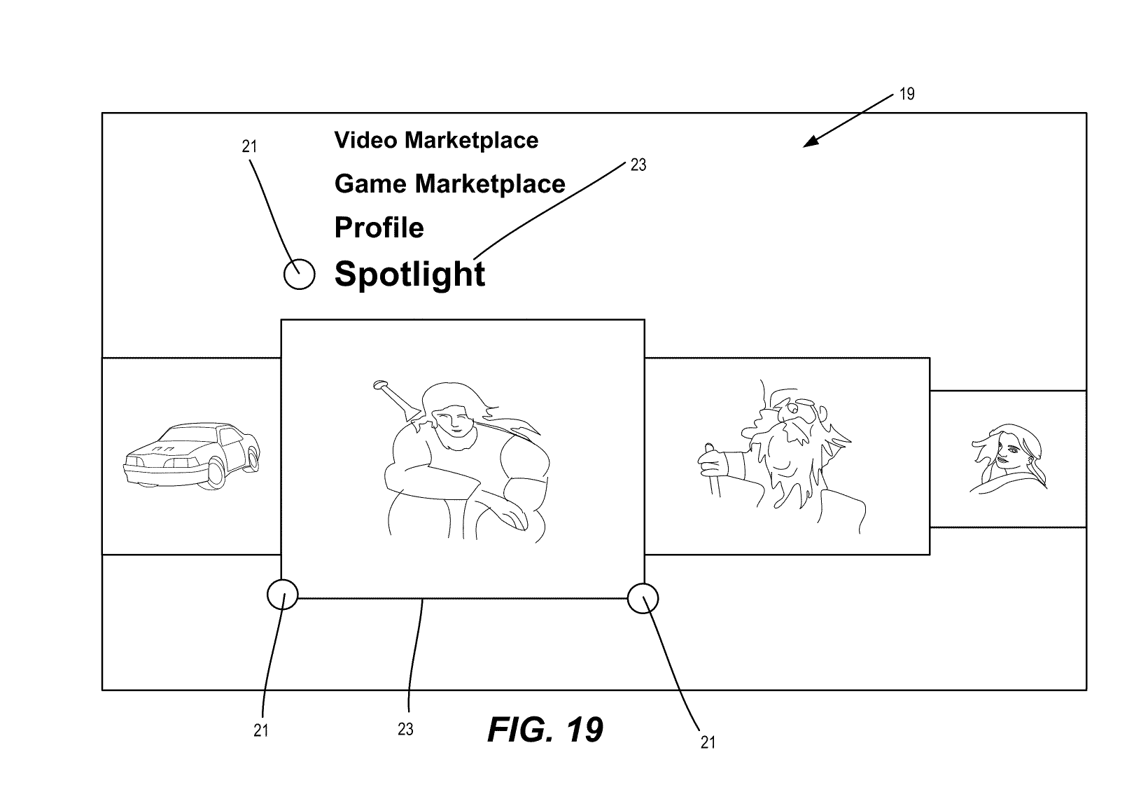

FIG. 18 includes an example of a single-handed handle 21. FIG. 19 is an illustration of a display including additional examples of handles. The handle 21 toward the top of the UI 19 in FIG. 2 is a single-handed handle 21 associated with an action area 23, which in this example is a textual navigation menu. The two handles 21 toward the bottom of the UI 19 are examples of dual-handed handles associated with an action area 23. In the example of FIG. 2, the action area 23 is one or more graphical navigation objects (also called “slots”) showing particular software titles on which some action may be performed by a user selecting both handles 21 at lower corners of a slot.

Different handles 21 may also be capable of different movements when engaged by a user. For example, some handles are constrained to move in a single direction (e.g., along the x-axis or y-axis of the screen). Other handles are provided for two axis movement along the x-axis and the y-axis. Further handles are provided for multi-directional movement around an x-y plane. Still further handles may be moved along the z-axis, either exclusively or as part of a multi-dimensional motion. Each handle may include affordances for clearly indicating to users how a handle may be manipulated. For example, when a user approaches a handle 21, graphical indications referred to herein as “rails” may appear on the display adjacent a handle. The rails show the directions in which a handle 21 may be moved to accomplish some action on the associated action area 23. FIG. 18 shows a rail 27 which indicates that the handle 21 may be moved along the x-axis (to the left in FIG. 18). As indicated, rails only appear when a user approaches a handle 21 or engages a handle 21. Otherwise they are not visible on the screen so as not to clutter the display. However, in an alternative embodiment, any rails associated with a handle may be visible at all times its handle is visible.

In further embodiments, the cursor 25 may also provide feedback and cues as to the possible handle manipulations. That is, the position of cursor may cause rails to be revealed, or provide manipulation feedback, in addition to the handle itself.

FIG. 20 shows a screen illustration of FIG. 19, but at a later time when a user has attached to the handle 21 near the top of the screen. As such, rails 27a and 27b are displayed to the user. The rail 27a shows that the user can move the handle up or down. The action associated with such manipulation of handle 21 would be to scroll the text menu in the action area 23 up or down. In one embodiment, the user can perform a vertical fling gesture to cause scrolling the text up or down after engaging the handle. The rail 27b shows that the user can move the handle to the right (from the perspective of FIG. 20). The action associated with such a manipulation of handle 21 would be to scroll in the action area 23 to a sub-topic of the menu item at which the handle is then located. Once scrolled to a sub-topic, a new horizontal rail may appear to show the user that he or she can move the handle to the left (from the perspective of FIG. 20) to return to the next higher menu.

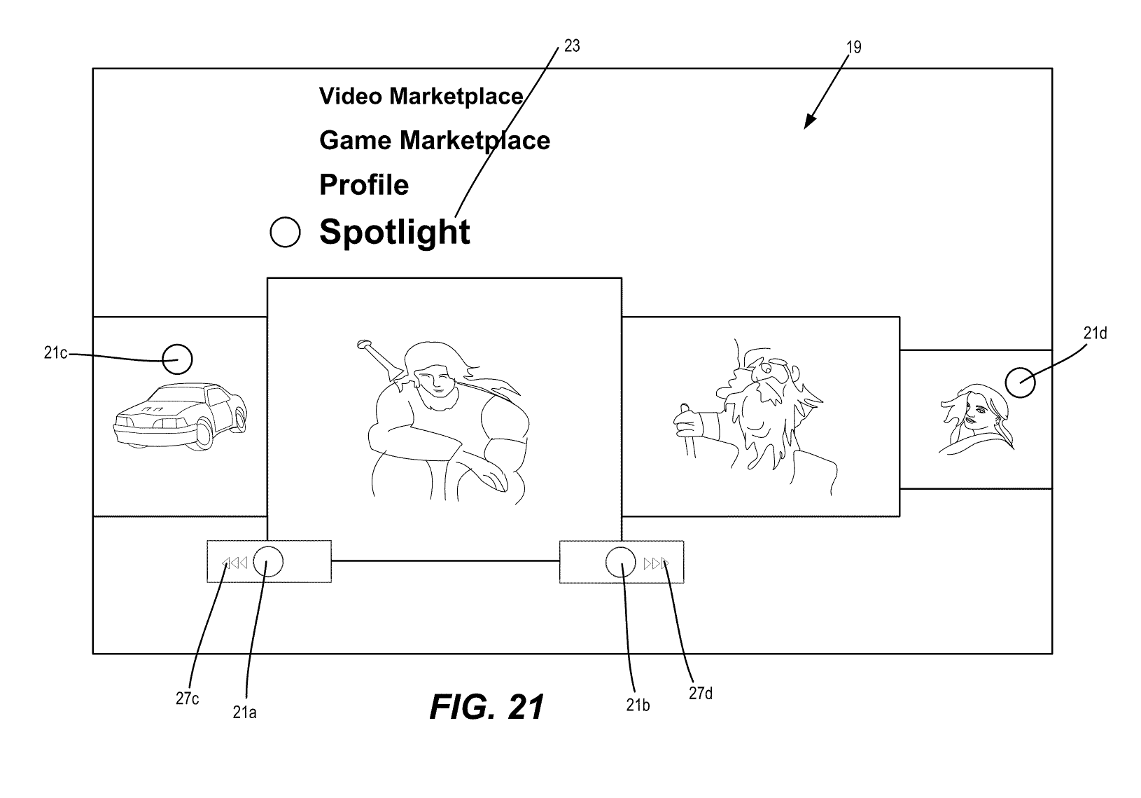

FIG. 21 shows a screen illustration of FIG. 19, but at a later time when a user has attached to the handles 21a, 21b near the bottom of the screen. As such, rails 27c and 27d are displayed to the user. The handles 21a, 21b and rails 27c, 27d displayed together at corners of a slot show that the user can select that slot with two hands (one on either handle). FIG. 21 further shows handles 21c and 21d toward either side of the UI 19. Engagement and movement of the handle 21c to the left (from the perspective of FIG. 21) accomplishes the action of scrolling through the slots 29 to the left. Engagement and movement of the handle 21d to the right (from the perspective of FIG. 21) accomplishes the action of scrolling through the slots 29 to the right. In one embodiment, a user can perform a horizontal fling gesture to cause scrolling of the slots left or right after engaging the handles. The two-handed select gesture as depicted in FIG. 21 may follow the reverse compression pattern earlier described in FIGS. 17A-17B.

More information about recognizer engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009. Both of which are incorporated by reference herein in their entirety. More information regarding handles can be found in U.S. patent application Ser. No. 12/703,115, entitled “Handles Interactions for Human-Computer Interface.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method of operating a user-interface using mid-air motion of a human target, comprising:
receiving a plurality of images from a capture device, the plurality of images including the human target;
tracking movement of the human target from the plurality of images using skeletal mapping of the human target;
determining from the skeletal mapping whether the movement of the human target satisfies one or more filters for a first mid-air gesture, the one or more filters specifying that the first mid-air gesture be performed by a particular hand or by both hands; and
if the movement of the human target satisfies the one or more filters, performing at least one user-interface action corresponding to the mid-air gesture.

2. A method according to claim 1, further comprising:
providing at least one gesture filter corresponding to each of a plurality of mid-air gestures, including providing the one or more filters for the first mid-air gesture;
determining a context of the user-interface;
determining a set of viable mid-air gestures corresponding to the context of the user-interface, the set including the first mid-air gesture and less than all of the plurality of mid-air gestures; and
in response to determining the context of the user-interface, only determining from the skeleton mapping whether the movement of the human target satisfies the at least one gesture filter corresponding to each of the viable mid-air gestures in the set.

3. A method according to claim 1, wherein:
the first mid-air gesture is a horizontal fling gesture;
determining whether the movement of the human target satisfies the one or more filters for the horizontal fling gesture includes:
determining whether a position of a hand of the human target satisfies a starting position parameter,
determining whether a direction of movement of the hand from the starting position satisfies a directional parameter, and
determining whether a distance traveled by the hand during the movement satisfies a distance parameter,
determining whether the movement of the hand satisfying the distance parameter occurs within a time parameter.

4. A method according to claim 3, wherein the at least one user-interface action corresponding to the horizontal fling gesture includes a horizontal scrolling action of menu items of the user-interface, the method further comprising:
horizontally scrolling the menu items of the user-interface by a first amount when the distance traveled by the hand is a first distance; and
horizontally scrolling the menu items of the user-interface by a second amount when the distance traveled by the hand is a second distance, the first amount being less than the second amount and the first distance being less than the second distance.

5. A method according to claim 3, wherein the at least one user-interface action corresponding to the horizontal fling gesture includes a horizontal scrolling action of menu items of the user-interface, the method further comprising:
determining a velocity of the hand during the movement of the hand;
horizontally scrolling the menu items of the user-interface by a first amount when the velocity is a first velocity; and
horizontally scrolling the menu items of the user-interface by a second amount when the velocity is a second velocity, the first amount being less than the second amount and the first velocity being less than the second velocity.

6. A method according to claim 3, wherein the horizontal fling gesture is a right-handed horizontal fling gesture and the hand is a right hand of the human target, the method further comprising:
filtering to remove skeletal mapping information of a left hand of the human target when determining whether the movement of the human target satisfies the one or more filters for the right-handed horizontal fling gesture.

7. A method according to claim 1, wherein the first mid-air gesture is a vertical fling gesture and the at least one user-interface action corresponding to the vertical fling gesture includes a vertical scrolling action of menu items of the user-interface, the method further comprising:
determining a velocity of the hand of the human target in performing the vertical fling gesture;
vertically scrolling the menu items of the user-interface by a first amount when the velocity of the hand is a first velocity; and
vertically scrolling the menu items of the user-interface by a second amount when the velocity of the hand is a second velocity, the first amount being less than the second amount and the first velocity being less than the second velocity.

8. A method according to claim 1, wherein:
the first mid-air gesture is a press gesture;
the at least one user-interface action corresponding to the press gesture includes a selection of a menu item of the user-interface;
determining whether the movement of the human target satisfies the one or more filters for the press gesture includes:
determining whether a position of a hand of the human target satisfies a starting position parameter,
determining whether a direction of movement of the hand from the starting position satisfies a directional parameter, the directional parameter corresponding to movement of the hand of the human target away from the human target's body and towards the capture device,
determining an ending position of the hand of the human target,
determining whether a distance traveled by the hand during the movement satisfies a distance parameter,
determining whether the movement of the hand satisfying the distance parameter satisfies a time parameter; and
performing selection of a menu item includes selecting a first menu item corresponding to the ending position of the hand of the human target.

9. A method according to claim 1, wherein:
the first mid-air gesture is a back gesture;
the at least one user-interface action corresponding to the press gesture includes navigating backwards within the user-interface;
determining whether the movement of the human target satisfies the one or more filters for the back gesture includes:
determining whether a position of a hand of the human target satisfies a starting position parameter,
determining whether a direction of movement of the hand from the starting position satisfies a directional parameter, the directional parameter corresponding to movement of the hand of the human target away from the capture device and towards the human target's body.

10. A method according to claim 1, wherein:
the mid-air gesture is a two-handed press gesture;
the at least one user-interface action corresponding to the two-handed press gesture includes navigating backwards within the user-interface;
determining whether the movement of the human target satisfies the one or more filters for the two-handed press gesture includes:
determining whether a position of a right hand of the human target satisfies a first starting position parameter,
determining whether a position of a left hand of the human target satisfies a second starting position parameter,
determining whether a direction of movement of the right hand from its starting position satisfies a first directional parameter, the first directional parameter corresponding to movement of the right hand away from the human target's body and towards the capture device,
determining whether a direction of movement of the left hand from its starting position satisfies a second directional parameter, the second directional parameter corresponding to movement of the left hand away from the human target's body and towards the capture device,
determining whether the movement of the left hand and the movement of the right hand satisfy a coordination parameter.

11. A method according to claim 1, wherein:
the mid-air gesture is a two-handed compression gesture;
the at least one user-interface action corresponding to the two-handed compression includes navigating backwards within the user-interface;
determining whether the movement of the human target satisfies the one or more filters for the two-handed press gesture includes:
determining whether a position of a right hand of the human target satisfies a first starting position parameter,
determining whether a position of a left hand of the human target satisfies a second starting position parameter,
determining whether a direction of movement of the right hand from its starting position satisfies a first directional parameter, the first directional parameter corresponding to movement of the right hand toward a left side of the human target's body,
determining whether a direction of movement of the left hand from its starting position satisfies a second directional parameter, the second directional parameter corresponding to movement of the left hand toward a right side of the human target's body,
determining whether the movement of the left hand and the movement of the right hand satisfy a coordination parameter.

12. A method according to claim 1, wherein the plurality of images is a plurality of depth images.

13. A system for tracking user movement to control a user-interface, comprising:
an operating system providing the user-interface;
a tracking system in communication with an image capture device to receive depth information of a capture area including a human target and to create a skeletal model mapping movement of the human target over time;
a gestures library storing a plurality of gesture filters, each gesture filter containing information for at least one gesture, wherein one or more of the plurality of gesture filters specify that a corresponding gesture be performed by a particular hand or both hands; and
a gesture recognition engine in communication with the gestures library for receiving the skeletal model and determining whether the movement of the human target satisfies one or more of the plurality of gesture filters, the gesture recognition engine providing an indication to the operating system when one or more of the plurality of gesture filters are satisfied by the movement of the human target.

14. A system according to claim 13, wherein:
the gesture recognition engine determines a context of the user-interface and in response, accesses a subset of the plurality of gesture filters corresponding to the determined context, the subset including less than all of the plurality of gesture filters, the gesture recognition engine only determining whether the movement of the human target satisfies one or more of the subset of the plurality of gesture filters.

15. A system according to claim 13, further comprising:
at least one first processor executing the operating system, gestures library and gesture recognition engine;
the image capture device;
at least one second processor receiving the depth information from the image capture device and executing the tracking system, the depth information including a plurality of depth images.

16. A system according to claim 13, wherein:
the plurality of gesture filters includes a vertical fling gesture filter, a horizontal fling gesture filter, a press gesture filter, a back gesture filter, a two-handed press gesture filter and a two-handed compression gesture filter.

17. One or more processor readable storage devices having processor readable code embodied on the one or more processor readable storage devices, the processor readable code for programming one or more processors to perform a method comprising:
providing at least one gesture filter corresponding to each of a plurality of mid-air gestures for controlling an operating system user-interface, the plurality of mid-air gestures including at least two of a horizontal fling gesture, a vertical fling gesture, a one-handed press gesture, a back gesture, a two-handed press gesture and a two-handed compression gesture;
tracking movement of a human target from a plurality of depth images using skeletal mapping of the human target in a known three-dimensional coordinate system;
determining from the skeletal mapping whether the movement of the human target satisfies the at least one gesture filter for each of the plurality of mid-air gestures; and
controlling the operating system user-interface in response to determining that the movement of the human target satisfies one or more of the gesture filters.

18. One or more processor readable storage devices according to claim 17, wherein the horizontal fling gesture is a right-handed horizontal fling gesture, the method further comprising:
filtering to remove skeletal mapping information of a left hand of the human target when determining whether the movement of the human target satisfies the at least one gesture filter for the right-handed horizontal fling gesture.

19. One or more processor readable storage devices according to claim 17, wherein the method further comprises:
generating a handle associated with an area of the operating system user-interface; and
detecting engagement by the human target with the handle;
wherein determining whether the movement of the human target satisfies the at least one gesture filter only determines whether movement of the human target while engaged with the handle satisfies the at least one gesture filter.

20. One or more processor readable storage devices according to claim 17, wherein:
determining whether the movement of the human target satisfies the vertical fling gesture includes determining a velocity of a hand of the human target when performing the vertical fling gesture;
controlling the operating system user-interface in response to determining that the movement of the human target satisfies the vertical fling gesture includes vertical scrolling a list of menu items provided by the user-interface by a first amount when the velocity of the hand of the human target is equal to a first velocity and vertically scrolling the list of menu items provided by the user-interface by a second amount when the velocity of the hand of the human target is equal to a second velocity, the first amount being less than the second amount and the first velocity being less than the second velocity.
